(19) United States
(12) Patent Application Publication
(10) Pub. No.: US 2015/0032579 A1
(43) Pub. Date: Jan. 29, 2015

(54) METHOD, SYSTEM AND DEVICE FOR PROVIDING SUPPLIER RELATED FINANCING

(71) Applicant: Kim Lionel JACOBS, Mosman, Newe South Wales (AU)

(72) Inventor: Kim Lionel Jacobs, New South Wales (AU)

(21) Appl. No.: 14/378,531

(22) PCT Filed: Jan. 14, 2014
(86) PCT No.: PCT/AU2014/000018

§ 371 Date: Aug. 13, 2014

(30) Foreign Application Priority Data
Jan. 16, 2013 (AU) 2013900138

(51) Int. Cl. G06Q 30/06

(52) U.S. Cl. CPC G06Q 30/0637
USPC 705/26.82

(57) ABSTRACT

A computer program product embodied in a computer readable storage medium for providing supplier related financing to one or more Goods and Services Providers (GSPs), the computer program product comprising programming instructions for: a) authentication of a Purchase Order (PO) sent to a Goods and Services Provider (GSP) from a Payment Procedure Specific Organisations (PPSO) such as an insurance company; b) publication of the GSP's requirement for supply of one or more parts and/or services, for viewing by one or more potential suppliers; c) matching of said offers of supply in the form of trade credit from one or more suppliers to the GSP's requirements and/or the associated PO specification; and d) presentation of said preferential offers of supply to said GSP.

### FIELD OF INVENTION

The present invention relates to an automated method, system and device for improving establishment of credit standing and in particular increased access to trade credit by goods and services providers so as to improve the efficiency in which money flows between transacting parties.

### BACKGROUND

### Trade Credit

Businesses Goods and Services Providers (GSPs) usually have to provide goods or services before they get paid (the provision of this unsecured debt to their customers is commonly referred to as Trade Credit). This provision of goods and services often involves a considerable risk since payment for those goods/services may be delayed or not made as agreed.

Consequently, there is a need by GSPs to, in turn, obtain trade credit from their suppliers. If there is insufficient trade credit available, to GSPs from these suppliers, then difficulties arise. Currently, even when trade credit is available, it is difficult and time consuming to obtain.

There is a need for an alternative approach to sourcing trade credit that:

(1) increase the availability of trade credit to GSPs; and
(2) promotes the comfort of supplier's provision of trade credit to their GSP customers, which in turn, will enable trade credit to be more efficiently obtained by these GSPs.
How Trade Credit Impediments are Currently Dealt with

In circumstances where the required trade credit is either:
1) not made available; or
2) not made available in the volume required;
   then alternate means to obtain credit are used.

GSPs have pursued the following approaches (or hybrids of the following) as examples of such alternate means:
a) seeking trade credit sufficient only to enable individual transactions in a highly restrictive manner, which is:
   i. practical for large value transitions only; and
   ii. not cost effective for the numerous small value transactions that most GSPs provide;
b) payment of cash on delivery, or payment in advance into trusts/escrows before goods and/or services are delivered to the GSP by its supplier. Both of these adversely consume cash;
c) discounts to end consumers of the GSP to encourage early payment, so GSPs can receive the cash quickly from their customer that they need to use, in turn to, pay their suppliers. This is relatively expensive because it requires an unacceptably high early payment discount to have the funds released early to the GSPs; and/or
d) Bank's Letter of Credit and/or Performance Bonds can also be supplied by GSPs to their suppliers. However these are only available to those GSPs who already have good credit standing with a bank, which many smaller GSPs lack.

### Consequences of the Above Methods of Providing Trade Credit

The problems with overcoming impediments using the above methods is that only after GSPs achieve sales, can their successful sales efforts then be used to obtain the necessary trade credit.

But GSPs, without access to adequate trade credit, often cannot obtain these sales in the first place because they cannot meet their customer's needs on a timely basis. Consequently, GSPs often have to reduce their potential client base, since they cannot arrange the necessary trade credit. Therefore, a sales campaign by a GSP for potential clients is problematic, since timely delivery of goods and/or services they need to obtain to onsell cannot be guaranteed.

There is a need for a system, method and device that efficiently provides trade credit financing to GSPs early in the process when they are bidding for new business and provides it in the volume required, whilst reducing the risk to their suppliers in providing such trade credit. This would assist GSPs to expand their available customer base (and thereby increase the competition in the economy). Further, it would provide a means for smaller GSPs to supply more competitively, even to potentially the largest customers.

### The Risk of Providing Trade Credit

The risk in providing trade credit is that the credit provider may experience:
1) non-payment; or
2) a greatly delayed payment;
   against the invoice that created the trade credit.

Non-payment results in a financial loss, whilst delayed payment limits cash availability. Therefore, a supplier offering trade credit to a GSP, who is impacted by a non-payment or delayed payment, has no funds to reinvest.

In practice, trade credit suppliers often have to wait for their GSP customers to pay other more pressing outstanding debts, which in tight markets make trade credit suppliers more cautious. A trade credit supplier to a GSP may also experience delayed payment because their GSP customer, in turn, has to wait for the GSP's end customer to pay for services received.

If the end customer defaults and never pays the GSP, that GSP may be unable in turn to pay its suppliers. It is therefore possible for a large company to collapse and, in turn, “pull down” a range of smaller businesses with it, even though they are several steps removed from the cause of the collapse.

Payment of trade credit is problematic where:
a) the payer is not credit worthy (a problem common to many smaller GSPs); and/or
b) receipts due to the GSP from its customers involve the GSP satisfying rigid procedurally based protocols to, for example, a Payments Department before any funds flow to the GSP.

GSPs that have unpaid invoices owing to them often suffer from a lack of cash flow. Cash flow for GSPs is the make or break of their success. There have been many attempts to date to provide a method to ease cash flow lumpiness within GSPs.

### Known Means for Providing Trade Credit

The easiest way a GSP can deal with fluctuations in its inwards cash flow that it receives from its customers is if they can obtain trade credit from their suppliers. Cash flow from customers permits a GSP to repay debts owed to suppliers for previously supplied goods and/or services. Trade credit (along with cash and undrawn financial debt) is the necessary buffer between the differences in cash inflows and outflows within a GSP so it can pay its way.

Cash flow receipt from successful sales activities can vary for a GSP. For example, payment received from the invoice rendered can take place at any time in the following range:
a) immediately on the date of issuance of the invoice that requires payment; to
b) a future date, where the receipt of payment may take days, weeks, months and even years after the invoice was first issued.

When there is a delay between the invoice issuance and the invoice payment, the cash represented by the unpaid invoice is locked up and inaccessible to the GSP, restricting its ability to do more business or even meets its expenses on a timely basis. A GSP reputation for slow payment will, in turn, restrict the trade credit available to it, compounding an already difficult situation.

The payment of most GSPs invoices is occurring, commonly, after 30 days post issuance of the invoice by the GSP to the debtor. This means by the time these 1.0 invoices are paid there are other new invoices that have been issued by the GSP for new sales which also need funding by either cash, undrawn debt or trade credit available to the GSP.

Consequently, across the economy, GSPs that sell goods or services typically have a large amount of potential funds locked up, or inaccessible to them, but held by their debtors. The slow inflow of its cash and limited trade credit is a major constricting factor on the growth of a GSP.

GSPs may cost the inaccessibility of their funds, tied up by their debtors in delayed or non-payment, into their invoices. Consequently, these costs:
a) are either passed on to their customers, perhaps via high prices (which limits the GSP's price competitiveness); or
b) act as an impediment for the GSP to compete for the larger business opportunities because they will “tie up” too much of their funds for too long. Consequently, many GSPs must leave such opportunities to their financially stronger competitors.

This reduces the competitiveness of the smaller, more financially constrained GSPs compared to their larger peers who don't face such financing problems. This lowers competition between GSPs for the supply of goods and services to customers across the whole economy.

### Known Methods to Improve GSP's Financial Resources

(i) Increasing Cash Flow from Customers

A method for reducing the quantity of funds tied up in an inaccessible form, such as unpaid accounts receivable, is to offer inducements for the customer to settle a GSP's invoice early. For example, a discount of (say) 15% can be applied if the invoice is paid (say) within seven days. However, if the invoice is settled after 30 days, then a monthly loading of compound interest can be applied at a percentage above the cash rate to the value of the GSP's invoiced amount (if the customer will accept this, but many will not).

### (ii) Factoring

GSPs can increase the cash available it by using “factoring”, where the GSP sells its outstanding invoices to a “Factor” (a separate business) at a discount (that is for less than their fully invoiced amount) in exchange for an immediate payment from the Factor who then owns the invoice and the debt.

For example, a first payment by a Factor to the GSP for the invoice is usually some percentage, say 70%, of the equivalent value of the outstanding invoices, so that the GSP only receives 70% of the value initially from the Factor with 30% of the invoice value being retained by the Factor as a “buffer”.

When a GSP sells its invoices to a Factor, the Factor then takes on the role of obtaining the cash equivalent of the invoice from the debtor (in full and promptly), by applying its debtor collection skills and general administrative expertise in this area that is usually well above that of most GSPs. This is because achieving prompt payment must be one of the core skills of any successful Factor, but it is often not one of the strong skills of the GSP that is factoring its invoices.

Factoring frees the GSP from the task of collecting debts from their customers and instead it can focus on being the best seller of goods and services it can be.

When the Factor is finally paid by the customer for the GSPs invoice it then deducts its fees and charges out of the 30% buffer and remits the net to the GSP.

### GSP Access to a Factor

Factoring is not an option available for many GSPs since:
1) a GSPs debtors must be seen by a Factor as of sufficiently good credit standing, to be able to pay the invoices the GSP will issue to them; and
2) the Factor may be concerned there are potential impediments if the invoiced amount owed by the debtor could subsequently be in dispute.

The last two problems arise because factoring requires clear agreement between the purchaser and the seller (the GSP), such that if the purchaser had bought X-widgets for Y dollars from the GSP, then the debt of Y dollars to the GSP will not be easily disputed.

Problems arise for many reasons even when the delivery to the debtor of X widgets for Y dollars was successful, for example:
1) the condition of the goods delivered may be disputed;
2) the agreed time frame of delivery may be unclear; or
3) the required and actual method of delivery is different.

The Factor may decide it's too hard to obtain the level of assurance it needs on all these matters if it is to be able to provide factoring to a GSP.

US Patent No. US 2002/0082985 deals not with GSPs of weak credit standing but with those of high credit standing who already have trade credit available to them and is a method they can derive early payment discounts from their suppliers.

US Patent No. 2006/0173772 is the application of techniques common in international trade finance via bank letters of credit and performance bonds to now include domestic transactions with both banks and now also nonbanks being involved to sponsor or guarantee financial performance. It requires a GSP to be able to obtain bank or non-bank sponsors for their trade credit obligations. It also incorporates factoring via a funding company, where a GSP enters into an agreement so as to obtain accelerated payment of the GSP's trade credit obligations in exchange for providing a percentage discount on the face value of its supplier's invoice. Such factoring companies are also referred to as sponsoring companies, which may have an automated handling process, for example, as specified in Patent No. WO 2006/083755.

More recently, as disclosed in Patent No. US 2011/0015974, such factoring companies have included financial institutions to provide capital (or funding) against a commitment of a GSP, to enable it to be settled early for a reduced amount. The GSP and the financial institution then share in the net difference between them; however, this does not appear to be different to obtaining a loan and entails the obstacles that are known to impede transactions to date.

There is a need for a method, system and device that efficiently provides GSPs, including those of weak credit standing, at least of the following benefits:
1. provide improved access to trade credit;
2. reduce the financial risk to providers of trade credit to GSPs; and
3. enhance management procedures to enhance efficient settlement of accounts.

### OBJECT OF THE INVENTION

It is an object of the present invention to overcome or ameliorate at least one of the disadvantages of the prior art by providing an improved or alternative method, system and device for providing supplier related financing to GSPs, including GSPs of weak or non-existent financial standing.

According to one aspect of the invention there is provided computer program product embodied in a computer readable storage medium for providing supplier related financing to one or more Goods and Services Providers (GSPs), the computer program product comprising programming instructions for:
a) authentication of a Purchase Order (PO) sent to a Goods and Services Provider (GSP) from a Payment Procedure Specific Organisations (PPSO) such as an insurance company;
b) publication of the GSP's requirement for supply of one or more parts and/or services, for viewing by one or more potential suppliers;
c) matching of said offers of supply in the form of trade credit from one or more suppliers to the GSP's requirements and/or the associated PO specification; and
d) presentation of said preferential offers of supply to said GSP.

According to another aspect of the invention there is provided computer program method for providing supplier related financing to one or more Goods and Services Providers (GSPs), the method being performed by a processor and including the steps of:
a) authentication of a Purchase Order (PO) sent to a Goods and Services Provider (GSP) from a Payment Procedure Specific Organisations (PPSO) such as an insurance company;
b) publication of the GSP's requirement for supply of one or more parts and/or services, for viewing by one or more potential suppliers;
c) matching of said offers of supply in the form of trade credit from one or more suppliers to the GSP's requirements and/or the associated PO specification; and
d) presentation of said preferential offers of supply to said GSP.

According to further aspect of the invention there is provided system for providing supplier related financing to one or more Goods and Services Providers (GSPs) including:
(a) a computer program product as described; and
(b) a computer program method as described.

The invention enables Goods and Services Providers (GSPs) access to funds without the need for one or more financial sponsors such as banks. This is achieved by the device, method and system enabling GSPs the ability to seek supplier's trade credit against purchase orders that have been verified by the device, method and system so as to reduce the operating risk of granting trade credit to the GSP. The term “device” takes the form of a computer application in its many different forms.

For a better understanding of the invention and to show how it may be performed, a preferred embodiment and a selection of other embodiments will now be described, by way of non-limiting examples only, with reference to the accompanying drawings or examples.

### BRIEF DESCRIPTION OF THE DRAWINGS

A preferred embodiment of the invention will now be described, by way of example only, with reference to the accompanying drawings in which:

FIG. 1 illustrates a preferred embodiment of the system in a schematic diagram.

FIG. 2 illustrates a preferred embodiment of the present invention showing a flow chart of the steps forming the method.

FIG. 3 illustrates a preferred embodiment of the present invention showing the interface of the device with the approval status displayed as pre-verified against a PPSO.

FIG. 4 illustrates a preferred embodiment of the present invention showing the interface of the device with the original PO, followed by additional purchase orders with their approval still pending.

FIG. 5 illustrates a preferred embodiment of the present invention showing the interface of the device with a supplier's invoice as generated being linked to a purchase order.

FIG. 6 illustrates an alternative embodiment of the present invention showing the device's steps in handling a supplier's invoice as generated being linked to a purchase order in a pre-repair payment to suppliers by PPE (with or without subsequent factoring of GSP invoice by PPE after repair or service completed).

### DICTIONARY OF DEFINED TERMS

Table 1 is a dictionary of terms defined according to the invention. Terms defined in Table 1 are denoted with the use of capitalisation throughout the document. If a term is not capitalised then its plain meaning is to be construed, unless otherwise specified.

TABLE 1
Dictionary of defined terms

| Term | Description |
|---|---|
| PPSO | Payment Procedure Specific Organisations (PPSO) are |
| | organisations (such as insurance companies) who have specific |
| | policies and procedural requirements that must be satisfied so |
| | that other parties (such as GSPs) can successfully access funds |
| | from them promptly and in full for goods and services |
| | previously supplied to them on trade credit terms |
| PPE | Payment Procedure Expertise (PPE) is the knowledge for |
| | accessing funds from PPSO organisations. PPE is the knowledge |
| | of each PPSOs specific policies and procedural requirements |
| | along with the practical application of these requirements. PPE |
| | is often beyond the ability of most small GSPs. Consequently, |
| | the PPE requirements provides constraints on GSPs, since their |
| | ability and resources are limited and the number of PPSOs that |
| | a GSP must deal with may be large with each having their own |
| | PPE. |
| PPE Business | A PPE Business (such as a Factor) possesses PPE for a range of |
| | PPSOs. It is skilled in meeting the requirements to deal |
| | efficiently with PPSOs, so that accurate and fully documented |
| | invoices for goods and services supplied can be delivered from |
| | GSPs to PPSOs exactly where and how the PPSO wishes to |
| | receive them. This enables the timely payment of invoices. |
| | PPE Business knowledge is created from experience, trial and |
| | error and specific enquiry of PPSO's on how to produce timely, |
| | accurate and fully documented invoices to the correct |
| | department within a PPSO, in a form conforming to how such |
| | information is acceptable to be received. A PPE Business has |
| | the knowledge as to what area and to whom within a PPSO |
| | communication can take place to ensure that invoices get |
| | processed through the PPSOs system and paid promptly. These |
| | details can change frequently and it is a major focus of PPE |
| | Businesses to keep up to date with these changes within PPSOs. |
| Purchase Order | A PO is a written undertaking that the issuing PPSO, such as an |
| (PO) (or Repair | insurance company, gives to its selected GSPs committing that |
| Authority in the | the PPSO will pay to the value of the Purchase Order (called a |
| case of a Motor | Repair Authority by motor insurance companies) on the |
| Insurance | successful delivery to it of the listed goods and/or services |
| Company) | described on the PO. When dispatched, the PO usually requires |
| | requisition, similar to an invoice, attached and/or a form |
| | specifying the agreed amount to be paid to the GSP for the |
| | successful supply of the specified goods and services. It is |
| | equivalent to a bank's conditional Letter of Credit. |
| | With Motor Insurers, Repair Authorities, which are a form of a |
| | PO, may specify listed damage and other defects to be rectified |
| | to agreed standards using approved methods. Typically the |
| | repair authority may also identify safety and/or other criteria |
| | including specified items to be considered and allows for the |
| | GSP to come back and request approval for further work if more |
| | repair is required due to, say, additional damage being |
| | discovered during the initial repair. The PPSO is typically limited |
| | to pay within the bounds of the work to be performed at the |
| | value specified or quoted elsewhere plus any approval it gave |
| | for additional work. |

The elements of the invention are now described under the following headings:

### DETAILED DESCRIPTION OF A PREFERRED EMBODIMENT

Preferred embodiments of the present invention are now described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details. In other instances, well-known structures and elements are shown in block diagram form in order to facilitate describing the invention.

### PREFERRED EMBODIMENT

The preferred embodiment of the invention provides a new or alternative method, system and device for providing expedited supplier financing to a GSP.

The preferred embodiment of the device takes the form of a computer application with an interface, viewable directly or indirectly via, for example, a web interface, to enable one or more: GSPs, such as smash repairer(s) and their associated parts supplier(s), to examine and reconcile a PO, as issued from the PPSO to a GSP, so that at an agreed stage the supplier(s) can, if they wish, offer to supply the required parts. If the offer is successful, the supplier(s) attach their invoices to the PO (Repair Authority) with the legally binding consent of the GSP.

### Computer Enabled Transactions

The improvement enabled through the introduction of reconciled, matched and accepted computer enabled transactions to which the preferred embodiment is enabled is discussed below.

A method, system and device for providing supplier related financing when an agreement (including a promise to pay in the form of a PO from a PPSO) is enabled via a standalone device or as a module to plugin to existing transaction environments.

In the following description, numerous specific details are set forth to provide a thorough understanding of the present device. However, it will be apparent to those skilled in the art that the present device, method and system may be practiced without such specific details. In other instances, well-known elements have been shown in block diagram form in order not to obscure the present device, method and system in unnecessary detail. For the most part, details considering timing considerations and the like have been omitted inasmuch as such details are not necessary to obtain a complete understanding of the present device along with their accompanying method and system and are within the skills of persons of ordinary skill in the relevant art.

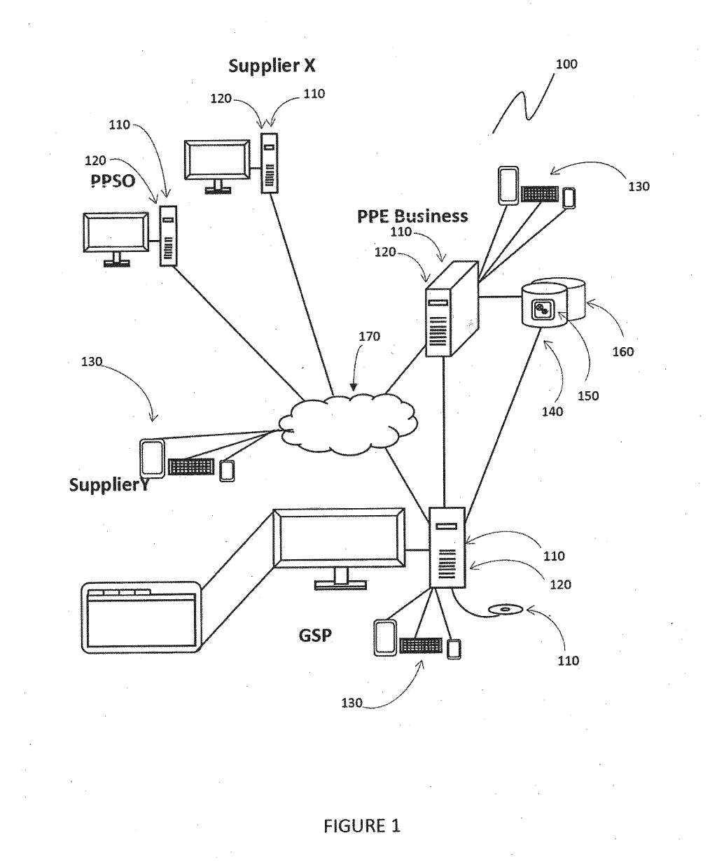

The principles of the present embodiment provides a credit enhanced environment by improving the accuracy and efficiency in transacting between a PPSO, a GSP and also (and most critically) between a GSP and its own suppliers where there is a linkage between these parties mediated via a PO (or a Repair Authority in the case of Motor Insurers) as discussed below in connection with FIG. 1. These transactions are also enabled to be mediated via a PPE business, if and when required.

This credit enhanced environment provides greater certainty of payment and/or the quicker flow of funds, from either from the PPSO or the PPE business to a GSP and its suppliers through the device performing the following functions:
a) authentication of a Purchase Order (PO) sent to a Goods and Services Provider (GSP) from a Payment Procedure Specific Organisations (PPSO) such as an insurance company;
b) publication of the GSP's requirement for supply of one or more parts and/or services, for viewing by one or more potential suppliers, who may also view the associated and authenticated PO, that nominates the GSP's requirement of supply;
c) matching of said offers of supply in the form of trade credit from one or more suppliers to the GSP's requirements and/or the associated PO specification;
d) identification and prioritisation of preferential offers of supply by costs, availability and/or quality in terms specified; and
e) presentation of said preferential offers of supply to said GSP; and preferentially
f) review of the GSP's list of similar repairs and their invoices to date.

The interface of the device when used by a PPE Business to connect GSPs with their suppliers also enhances the reliance in the relationship between GSPs and their suppliers because the PPE business is enabled via the tripartite agreement between all three parties to perform the steps appropriate to successfully establish and pay or settle trade credit between the parties.

FIG. 1 illustrates a network system for practicing the principles of the present device. Referring to FIG. 1, the device is a software device (computer program) that performs a credit enhancement method within a financial transaction system 100.

The financial transaction system 100 includes:
(a) a device (computer program product) residing in computer readable storage medium (memory) 110 for performing a credit enhancement method;
(b) a processing means (processor) 120 for operating the device; and
(c) input means 130 (not shown in FIG. 1 with regard to the PPSO and Supplier X) to enable a user to communicate with the financial transaction system, e.g. by inputting data.

The computer readable storage medium 110 can be memory in a storage medium such as a storage disk, a computer, a server, a network, or the cloud. In an embodiment, the system 100 includes access to a computer network 170 (including the internet or the cloud). The processing means 120 may be local or remote, via a network. A user may use a computer keyboard, smartphone, tablet, personal digital assistant or other mobile device or device with processing capacity to input data (e.g. a syllable, word or sequence of words).

A GSP, in using the device to perform PPE functions via the device's interface, as accessed via a secure website, is enabled to communicate with one or more:
a) suppliers, such as parts suppliers; and
b) PPSOs, such as insurance companies;
   through using the PO that is common between each GSP and the supplier(s), such that trade credit is provided by the supplier(s) to the GSP once the PO is verified by the device, which in an exemplary embodiment, is shown by the following steps:
   1. submit PO details, via the interface of the device, to seek PO ‘verification’;
   2. check documentation via inference engine 150 and transaction repository 160 of device and subsequently generates a report to communicate with PPSO, so as to confirm detail about the PO so the “Approved” status is verified;
   3. interrogates the ‘Transactions’ in the transaction repository 160, followed by checking the status of the ‘Transactions’ via the inference engine 150 so that the status of the PO can be verified as requiring action or being settled;
   4. verify that the PO is a new entity: if there are no transactions against the PO, then contact the PPSO to verify that the PO is valid;
   5. add the PO upon successful verification from the PPSO: the method uses the device to ‘add’ a new PO, by ticking the ‘Verify’ tick box on the device interface, clicks ‘Verify. Zone=N’, fills in Verification form with the relevant details, clicks ‘Completed’ button on Verification Form and changes ‘Status’ to ‘Approved’.

The method described above and below consists of steps described in a sequential order; however, such method may be configured to work in different orders, so that the order of steps does not necessarily indicate a requirement that the steps be performed in that order. Steps may also be performed in an iterative manner too, for example, accessing and searching a transaction repository to produce an agreement and/or to perform a search as to like agreements that have been performed and completed by the GSP historically.

The device includes computer readable program code (programming instructions) for performing the credit enhancement method, the method including the steps of:
(a) receiving a PO from a PPSO directly or from a GSP;
(b) inputting additional information, if required, into the device to be associated with the PO through a user interface of an input device 130 (e.g. a keyboard, smartphone, tablet, personal digital assistant or other mobile device or device with processing capacity) by the receiving party such as the GSP or a PPE business so as to enable such additional information to be entered for clarity of supply and delivery;
(c) verifying, the PO by the device and/or a PPE business to ensure that the PO is valid issued by the PPSO;
(d) communicating the PO details via the GSP by the device and/or the PPE business with other parties such as one or more suppliers of goods (e.g. parts) or services (expertise in an area), so that one or more suppliers can agree to the provision of services on agreed trade credit terms held against a specific PO;
(e) matching the offer and acceptance of terms by suppliers and the GSP respectively, such that agreements are performed with ancillary information combined such as delivery date, place of delivery, condition of goods and any other information that may be pertinent or specific to the situation of the agreement. This is optionally performed by the device operating an evaluation process which consists of a rule base/knowledge base 140 of undertakings between the parties with, in some embodiments, an inference engine 150 (a computer program designed to produce reasoning based on rules), which in turn will derive a transaction output (such as an invoice, an authorisation to perform work) based on the agreement matched by executing the undertakings and/or agreements possible between the parties based on the input's received;
(f) verifying that goods and/or services were performed to agreed terms from a rule base of agreed terms/undertakings and/or agreements possible and/or made between the parties (including one or more of the following parties such as the GSP, the device directly, a PPE business, and/or the supplier/specialist (the part's supplier and/or specialist mechanic in the example) as shown in 140; and optionally including the following steps in other embodiments;
(g) accessing and searching a transaction repository 160 containing a plurality of financial transactions to matching one or more financial transactions to the derived transaction output (such as an invoice, authorisation to perform work) based on the transactions performed historically and/or related to the capacity of the GSP to perform such tasks under specific workloads and environmental constraints; and
(h) publishing the transaction output via a report generator using detail from the transaction repository 160 (examples include an invoice, an authorisation to perform work, an agreement to receive parts as a trade credit on one or more particular term(s), or a report) based on the agreement matches which reflects an applicable PO's approvals giving rise to undertakings and/or agreements made between the parties (such as the GSP, the PPE business, and/or the supplier/specialist).

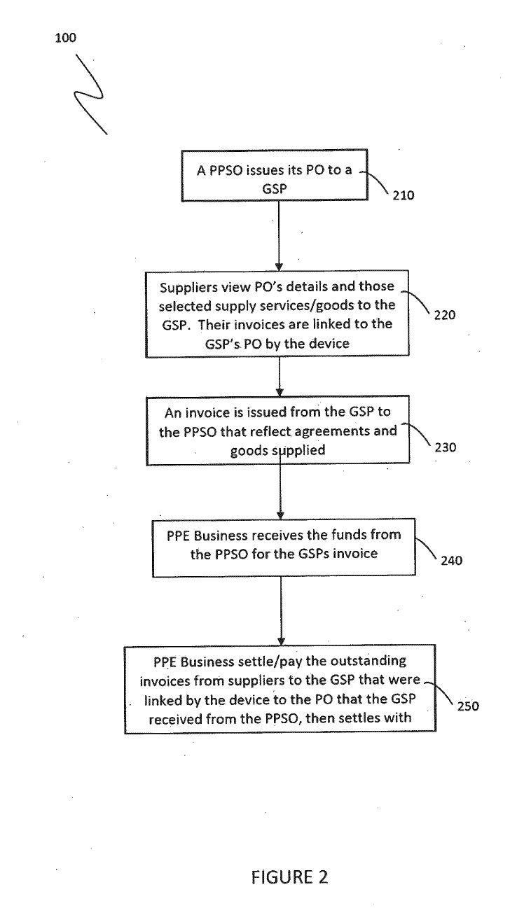

To present these details in a simpler form as shown in FIG. 2 as a flowchart of a method for transacting between a PPSO, a GSP and suppliers to the GSP and optionally a PPE business, where the linkage between these parties is via the PO (also referred to as a “Repair Authority”). There are many substeps performed in the above method as described in the description of FIG. 2 above.

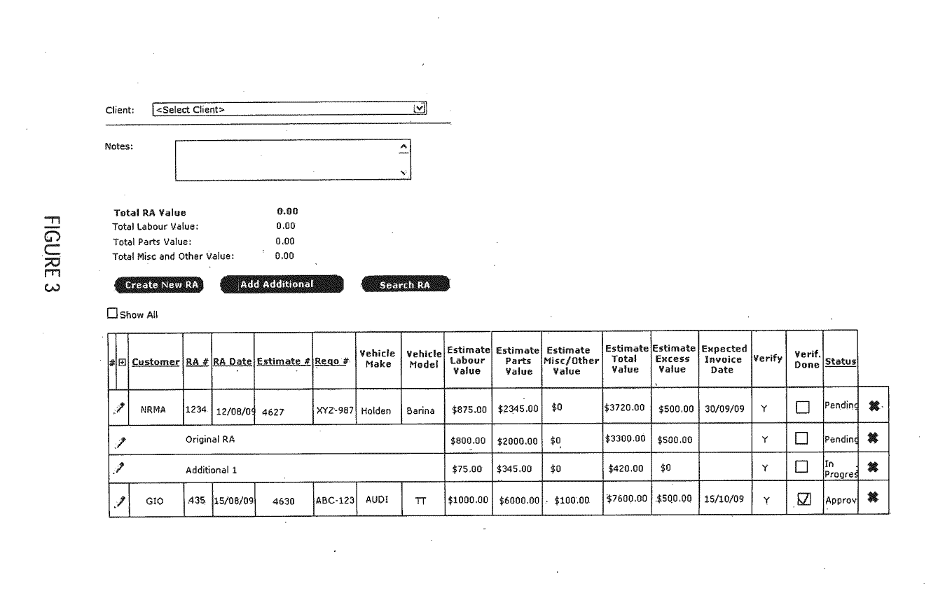

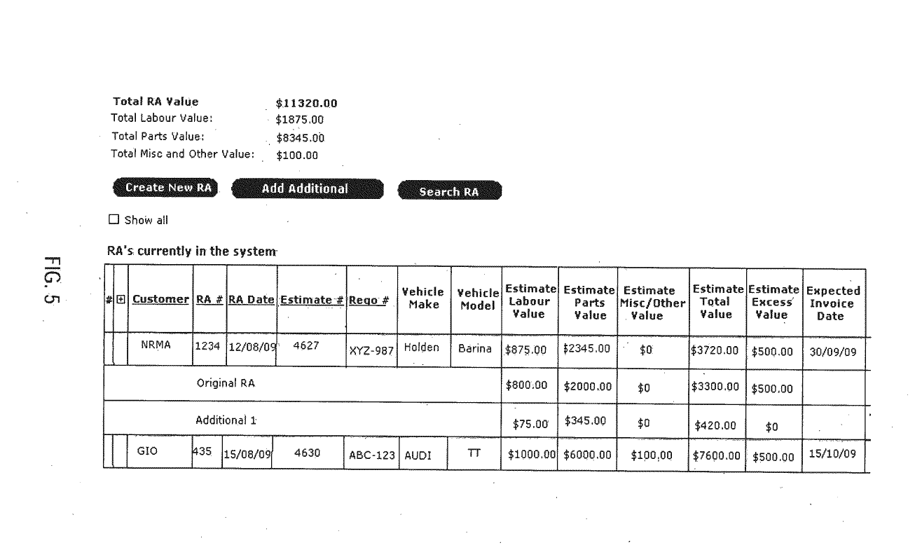

FIGS. 3 to 5 are screenshots showing various screens of the interface to the device at stages of transacting between parties, such as a GSP and its suppliers, using the device. A report may be generated depicting the results of these transactions between a PPSO, a PPE business and a GSP and suppliers to the GSP where there is a linkage between these parties via a PO, that may have multiple supplier's invoices, as captured and analysed by the device using the method of the preferred embodiment.

### Verification

The preferred embodiment in some arrangements has the device automatically verifying the PO, which is followed by the device publishing the PO details to potential supplier(s). Therefore, trade credit from the suppliers is facilitated by the device after verification of the PO. Here, the verification of the PO is achieved by the device directly receiving the PO from the PPSO on the GSP's behalf, so that the verification is automatically established.

In other arrangements the PO data is entered by the GSP into the device via the interface. Here, the verification must take place via the device before the PO is enabled to be submitted/published for notification and/or viewing by potential suppliers. The validity of the PO is performed by having a PPE business such as a Factor nominate the receipt of all POs from one or more PPSOs as “verified” based on the confirmed authenticated status of the PO as issued by the PPSO by the PPE Business directly with the PPSO or via the device.

This direct electronic communication between the many PPSOs is beyond the ability of most GSP's independent efforts (and certainly not practical for a GSP's suppliers) but is enabled by the device. Direct communication of a PO directly from the PPSO to a GSP via the device followed by verification and authentication via the device to suppliers lowers the risk of possible PO falsification and so enhances credit worthiness of the PO.

This facilitates the credit environment in which GSP suppliers can decide whether to advance trade credit arrangements to the GSP. The strength of the credit enhanced PO in the device, plus accessible business history of the GSP in satisfying similar conditional POs in the past (which is available via the device in some arrangements of particular embodiments), assists the decision being made by suppliers, to advance more trade credit to GSPs.

A PPE Business can also manually intervene to credit enhance the PO/Repair Authority by using its PPE skills to manually check the PO validity by contacting the PPSO.

The verified PO when published in various forms via the device's interface enables communication between the parties that viewed this PO such as the GSP and potential GSPs suppliers and optionally a PPE business. In alternative embodiments, a PPE business is enabled to independently co-ordinate and facilitate one or more supplier's invoices so that they are associated with a specific PO as presented by the GSP.

The validity of requests for trade credit from GSPs are therefore more accurately determined as valid by suppliers once the verified PO is published. Likewise, the ability of the GSP to satisfy the conditions attending to the PO's verification can be achieved with minimal effort. Consequently supplier trade credit to a GSP is finalised in a more efficient manner via an online offer and acceptance of requests, which are then linked as trade credit invoices to the verified PO.

As discussed above, the principles of the present device are enabled to be applied to many forms of a network system such as intranets and virtual private networks so as to allow the invitation of additional suppliers and GSPs into a secure environment if so required. This is particularly advantageous since a GSP's published PO may be specifying required quality parts and/or services and does not want to be ambushed by non-authentic suppliers in the form of spam offers.

Referring to FIG. 1, there is illustrated a network system 100 in accordance with an embodiment of the present interface. Network system 100 may include a device referred to herein as the “evaluator” which consists of a rule base/knowledge base 140 of undertakings between the parties with, in some embodiments, an inference engine 150. This evaluator is configured to apply the validity of the PO as discussed further below in connection with FIGS. 2 to 5. Furthermore, the evaluator is configured to apply the validity of PO links (connections to the GSP, the supplier invoices and optionally the PPE business and issuing PPSO) via the report generator via the transaction repository 160.

The device, through the action of the PO entering the rule base system 140, is subsequently validated through communication directly, or via a PPE business, with the PPSO. This is an automated action, which on receipt of a PO has the PPE information entered and accessible to communicate via the gateways of the PPSO. Such communication can also occur through the generation of the appropriate paper correspondence so as to join a critical piece of information, for example convening the GSP with the PPSO via the PO. There is a temporal relationship between the receipt of the PO via the GSP and the verification of the PO with the specific GSP. This communication can also take a myriad of other forms other than via paper correspondence referred to above.

### GSP Requirement Publication

Upon verification of the PO via the device with/or without the involvement of a PPE business, the device with authorisation from the GSP, is enabled to publish the PO listing the GSP's requirements.

GSP requirement publication, as supported as approved requirements by the PO, are enabled to be restricted or expanded by the device so that specific suppliers, such as those that are local or those that have specific specialisation(s), are enabled to be notified via the device's publication of requirements.

These GSP requirement reports and associated reports are published and accessible as to one or more suppliers so they can provide a GSP with goods and services as required. Informational reports are also provided when required and/or requested by and for selected viewing by parties such as linked PPE business, suppliers or GSPs. These informational reports are enabled to provide ancillary information such as to the size of the market each supplier or GSP is supplying to, and what markets one or more GSPs are servicing or what percentage of a GSP's business a Supplier is obtaining. Such informational reports are generated from the processing of the invoices involving suppliers and GSP's purchase orders.

### Agreement Generation

On acceptance of one or more supplier's offers, appropriate agreements with the requirement issuing GSP are generated by the device with specific terms if selected and required. These may be in addition to the standard contractual terms used within the industry or generated de novo.

On receipt of appropriate goods or services, these delivery receipt details are entered (usually by the GSP) into the interface of the device and confirmed by the counterparty, so that supplier's invoice's payment details can be attached to the GSP invoice and delivered to the PPSO (if required) either directly or via a PPE business.

### Payment of PO to Multiple Parties

The payment of the invoice that relates to the purchase order invoice by the PPSO is monitored by the device and reported to parties such as the GSP and/or the PPE business (if and when required). The device has a rule base for invoices submitted to the PPSO, so that there is the removal of error due to non-receipt or inappropriate/incomplete form submission. Consequently, the timing of Payment is available and reportable. This enables cash flow surety.

### Factoring of Invoices by the Device

In a further embodiment, the device via its rule base system is also enabled to factor an invoice, such that the certainty of payment to a GSP for a completed task and/or the work performed to date (or a date specified), is enabled to be paid for at a specific time period as specified and/or agreed to one or more parties such as the PPE Business, the suppliers and/or the GSP.

This factoring may take a percentage for ensuring the certainty of payment. The factoring is enabled to be proportional to the history of payment using the PPE expertise contained within the knowledgebase and/or used via a PPE business. For example, if 99% of invoices are paid within the week of submission by a PPE, when entered using the PPE submission information contained within the device, then there may be a 3% factoring by a PPE business against the GSP invoice submitted against the PO.

Referring back to FIG. 1, the Network system 100 may further include a PPE business server(s) configured to generate reports and transactions 160 between the party's (including the GSP and/or supplier(s) input and, in other embodiments, the PPSO(s)) input data into the device via a communication interface (website). The Evaluator, as discussed previously consists of a rule base/knowledge base 140, which is connected via a network to a GSP, the PPE sever and/or or parties. Network may refer to a Local Area Network (LAN) (e.g., Ethernet, Token Ring, ARCnet), or a Wide Area Network (WAN) (e.g., Internet) as shown in FIG. 1 via the cloud 170.

Additionally, the network system 170 may include a rule base/knowledge base 140 with a database configured as a transaction repository 160 to store PPE business's information as received, sent and transacted internally and from other parties such as the GSP and/or supplier related data as entered and computed.

FIG. 1 is not to be limited in scope to any particular embodiment and network system may be any system that includes an evaluator containing a rule base/knowledge base and at least one transaction repository 160.

### Transaction Steps

The steps for the transactions mediated by the devices are enabled by a computer mediated information environment, as discussed below in connection with FIG. 2, including the following steps:

1. A PPSO, such as an insurance company, issues its PO to a GSP as shown in step 210;
2. the GSP (in this example, a Smash Repairer), enters this PO detail into the device via the interface of the device, so suppliers can view a PO's details, and those supplier's (and/or their invoices) selected are enabled to supply services/goods to the GSP on agreed Trade Credit terms as held against the PO as shown in step 220;
3. An invoice is issued from the GSP to reflect agreements and goods supplied to the PPSO. This invoice may be transacted via a PPE Business as shown in step 230;
4. the PPE Business receives funds from the PPSO for the GSPs invoice; and
5. the PPE Business distributes these funds to first pay the suppliers, who may consist of one or more parties, and then the GSP from the funds remaining.

Alternatives to the above steps are enabled to be mediated by the device, such as adapting the above step to incorporate the situation where a PPE Business “buys” or factors the GSP's invoice and pays the suppliers for their invoices and sends the net proceeds to the GSP.

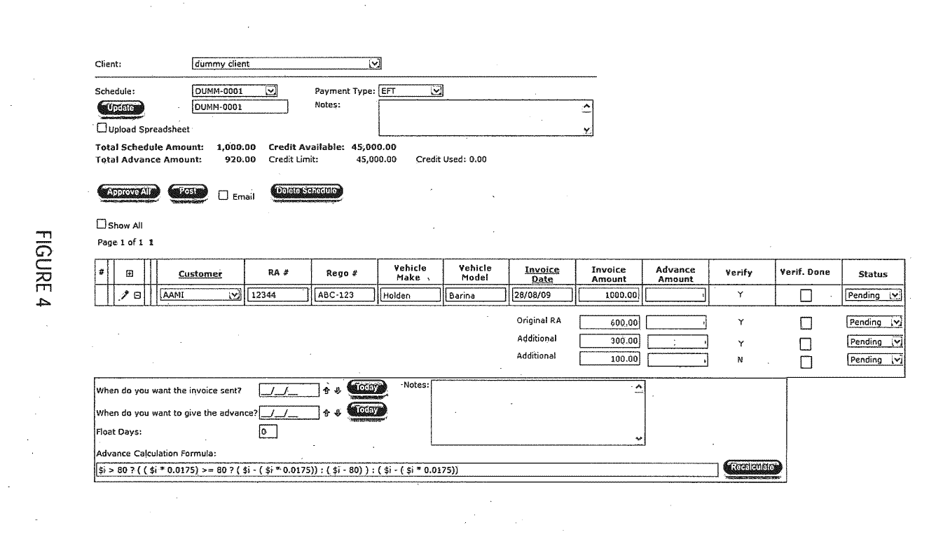

Additional substeps are also included as shown in the following example:
1) the PO is entered into the device by:
   a. a GSP, such as a smash repairer; or
   b. a PPE business, who has received the PO or Repair Authority documentation from a GSP such as smash repairer;
   c. by a PPE business who has received the PO or Repair Authority direct from the PPSO or Insurance Company on behalf of the GSP;
2) the PPE business and/or the GSP now flag the PO as “In Progress” or “Pending”, which signifies that they can view the PO; however, suppliers to the GSP, such as parts suppliers, cannot yet see this PO until it is approved by the PPE on the device. In other embodiments, the “In Progress” status will only be flagged if the client enters it, since if the PPE business enters the Repair Authority information after verifying it itself or if the PPSO supplies the information direct to the device on behalf of the GSP then the status can go straight to approved (step 4) as shown in FIG. 3;
3) verification of the PO is performed by an evaluator utilising the knowledge base of agreements 140, an inference engine 150 and using a transaction repository 160 as shown in FIG. 1. For example, the PPE business validates, via the evaluator, the PO's status against the submitted information/documents held in the transaction repository 160. This creates a decision point as to whether the PO is valid or not as held in the transaction repository 160. If the PO is not valid, then a request to validate information is made by communicating with the PPSO, and if provided, the device, with/without the services of a PPE business, via the evaluator will update the PO detail. If there is no validating information provided, then the transaction cannot proceed further and PO is verified as invalid in the transaction repository 160 of the device. False POs on the device are enabled to list the GSP responsible for the creation of an invalid or false PO. If the PO information is validated then proceed to the next step;
4) the PO's status via the evaluator is changed to “Approved” which means that suppliers, such as parts suppliers, can view the PO issued and its associated value and start preliminary business negotiation about the supply of trade credit to the GSP as shown in FIG. 3 and FIG. 4;
5) trade credit by a supplier to a GSP by using, the device for offer and acceptance of trade credit for supplier invoices can now be made as shown in FIG. 4.

The method may include other and/or additional steps that, for clarity, are not depicted. Further, method may be executed in a different order presented and that the order presented is illustrative. Additionally, certain steps in method may be executed in a substantially simultaneous manner or may be omitted.

In one embodiment, the status returned by the PPSO may indicate that the POs verified status is valid. This is optionally followed by the device providing a report offering the valid invoices relating to that PO to another party such as PPE business. If this PPE business is a Factor, the management, payment or other service(s) is enabled to be offered for purchase at a discount. The PPE business on purchasing these invoices, is then enabled to approve the GSP's subsequent invoice (provided it agrees with the POs details), with the means available to the PPE for payment allocation, via the device, to pay the GSPs supplier's invoices at the pre-agreed early payment terms.

Alternatively, the status returned by PPSO's communication may indicate that the PO's verified status is invalid. Additionally, the status returned by PPSO may indicate that there is an error. In addition, a PPSO may not provide any response, or in some cases, the status of the PO verified status is indeterminate. In these scenarios, the PPE business may not approve the subsequent purchase of the GSP's invoice that relates to this PO.

The device's evaluator may optionally update a PO from communications received. Therefore, if a PPSO communicates to the device that a PO's status is undeterminable, then there is an error in the information submitted, then this status will exist until the error is corrected.

Further, communications can include detail such as the following:
a) a GSP's communication may contain a list of PO/Supplier invoices as linked; or
b) a supplier's communication with multiple invoices rendered against multiple POs.

In these scenarios, the validity of one or more POs is listed as aggregated PO information. Updating the PO's validity may include removing the PO's verified status(s) from the evaluator as well as replenishing (i.e., reiterating the validity) of the PO verified status(s). It is noted that evaluator may update multiple supplier related trade financing on the application concurrently on the device automatically or via the input interface(s) of the device.

As discussed above, the application of the system, method and device may further include, for example, an application for transacting between one or more PPSOs, PPE businesses, GSPs and GSP supplier(s) where there is a linkage between these parties via a PO links (e.g., PPE business payment body) that activate a payment discount via the PPE business payment body.

In one embodiment, for example, when the evaluator receives one or more PO links with one or more PPSOs, PPE businesses, GSPs and GSP supplier(s), the evaluator obtains, the PO links from the Knowledgebase 140 as shown in FIG. 1, so that a PO link may refer to the authorising PPSO, with the associated supplier's invoice(s) and, in further embodiments, the PPE payment body that activates a discount (e.g., 10% off the face value of the supplier's invoice).

In a further substep, the evaluator accesses a supplier's invoice associated with the PO's link to an inference engine 150, so that in an additional step, the evaluator via the transaction repository 160, selects one or more payments to be settled.

In one embodiment, the PPE business, via the evaluator selects one or more GSP supplier payments to be initially paid, in connection with the received GSP invoice, as connected via a verified PO.

For example, if the GO supplier provides a 10% discount for the payment of its invoice, if paid at that time and is linked to a valid PO. Here, the GSP's invoice has been factored and is linked with the associated supplier's invoice, so that the payment is made at, for example, the agreed early payment discount of 10%.

In a still further substep, the evaluator adds (and/or deducts) selected debits and credits to the GSPs invoice(s) as required via the device.

In yet another substep, the evaluator initially determines if the PO, as linked to the supplier invoices, is valid based on the status of the PO returned by the PPSO's communication, or as determined by contacting the PPSO manually outside of the device.

For example, the status returned by the PPSO may indicate that the PO is valid so that the PPE business payment body applies the discount (e.g., 10% off the face value of the supplier's invoice) and pays the supplier's invoice. This payment may be made from either from:
i. proceeds of factoring of the GSP's invoice if the PPE business is a factor; or
ii. funds it has received directly from the PPSO for the GSP's invoice if it did not factor the GSP's invoice.

Other statuses that may be returned by PPSO are discussed above in connection with method.

In another further substep, the evaluator generates a report, via the transaction repository 160, to the PPE business and, if authorised, to the supplier based on the PO's status returned by PPSO. A detailed description of evaluator generating a report was discussed above in connection with method of the device checking the documentation, via the agreement repository 140 and the inference engine 150, so as to subsequently generate a report, via the transaction repository 160, to communicate with PPSO, so as to confirm detail about the PO to satisfy an “Approved” status is verified.

In still another further substep, the evaluator may optionally update an aggregated supplier (a supplier with a list of PO links) regarding the validity of one or more POs listed. A detailed description of evaluator updating an aggregator supplier was discussed above in connection with the method.

The method as implemented via the device may include other and/or additional steps and substeps that, for clarity, are not depicted. Further, method steps and substeps may be executed in a different order presented and that the order presented in the discussion is illustrative. Additionally, certain steps in the method may be executed in a substantially simultaneous manner or may be omitted.

Although the supplier related financing method, system and device's computer program are described in connection with several embodiments, it is not intended to be limited to the specific forms set forth herein, but on the contrary, it is intended to cover such alternatives, modifications and equivalents, as can be reasonably included within the spirit and scope of the interface of the device as defined by the appended claims.

This credit enhanced method enables expedited financing to a GSP by efficiently establishing a GSP's credit trustworthiness with the presence of a PO from a PPSO so additional “comfort” is able to be provided to a potential trade credit supplier, who is considering whether to supply trade credit to the potentially unknown GSP or, if previously known, to a GSP of low or unknown credit standing. Financial “comfort” is a term used to understand and reflect on the financial mindset of businesses of particular sizes such as small to medium enterprises. This “comfort” includes expectations and confidence, which can be enhanced with increased by providing an enhanced credit environment through increasing credit trustworthiness.

The establishment of a GSP's credit trustworthiness is performed using the following method via a device, as follows:
a) authentication of a PPSO's PO, as sent to the GSP, to perform a required supply of goods or service;
b) verification that the:
   a. GSP, which received the PO needs specified trade credit for suppliers part/services by reference to the detail on the PO; and/or
   b. PO will cover such trade credit supply as part of the PO;
c) display supply requirements, as specified in the PO, to potential suppliers;
d) display the GSP's past history of successfully completing similar PO's requirements; then
e) accept competitive offers from supplier(s) to the GSP, who decide to supply trade credit to GSP because they have increased assurances with the additional comfort provided by:
   a. the verified PO from the PPSO and/or
   b. the GSP's past history with similar PO's as displayed, and/or
   c. knowledge that they are scheduled to be paid at the same time as the GSP due to the intervention of the device to schedule payments at a preset time;
f) manage the GSP's invoice to the PPSO that contains debits being recorded in the system to prioritise the payment of supplier's invoices from trade credit suppliers, related to the above PO that subsequently gave rise to the GSP's invoice;
g) receive and submit the GSP's invoice to the PPSO;
h) follow up to ensure prompt and complete payment of the invoice and accept payment from PPSO;
i) settle the GSP's supplier invoices associated with the PO that relates to the GSP invoice now paid by the PPSO; and lastly and only then
j) settle the GSP's invoices with the GSP by paying it the value of its invoice, net of under PPSO underpayments (if any) and payments already made on its behalf by the PPE Business to trade credit suppliers associated with the invoice/PO and fees to the PPE Business

The GSP via the device's interface is accordingly provided with a mechanism for accessing and providing:
1. supplier financing from trade credits supplier(s); and
2. prompt payment from PPSO(s);
   without suffering the impediment of the GSP needing to:
a) satisfy extensive and time consuming credit checks conducted by the supplier; or
b) establish the expertise to access the payment protocols of PPSO's, such as insurance companies, before being paid in a timely manner.

The GSP does not need sponsors (bank(s) or otherwise) to guarantee the performance of its financial obligations to suppliers, since typically suppliers to GSPs are comfortable assessing the operating capacity of a GSP to successfully complete the PO, provided the suppliers to the GSP accept:
1. the credit strength of the PPSO behind the GSP's PO;
2. that the PO is an authentically issued PO via the PO's verification through the interrogation of the device, method and system in communicating with the PPSO, that substantiates the need for the requested items as legitimately requested; and
3. knowledge that the PPE Business has scheduled, via the device, to pay the supplier promptly as opposed to “delayed or stretched out” of the supplier by the GSP,
   thereby giving suppliers reduced risk when they take on the residual operating risk and supply trade credit to the GSP.

Suppliers are enabled to provide more trade credit earlier to GSPs of weak credit standing because the device, method and system used by the PPE Business transforms or greatly reduces the increased bare or unmitigated credit risk of the GSP that the suppliers would otherwise assume (that they are not best positioned to assess) and instead replacing this bare credit risk with the GSP's operating risk that most often they are ideally placed to assess far better than any other parties apart for the GSP itself.

It can be seen that in the device, method and system it is the quality of the PO issued by the PPSO to the GSP that is critical. In one embodiment of the invention the system provides for a means for PPSO's to supply authenticated PO's to the GSP, when requested by either the GSP or the PPE Business using the system, via a transmission direct to the system and copied to the GSP. In a further embodiment of the invention if the GSP already has an existing PO from a PPSO the PPE Business is enabled to authenticate the PO itself and record in the system the authenticated status of the PO for potential trade credit suppliers to view.

### GSP Operating Risk: Assessing a GSP's Ability to Complete Conditions Stipulated in a Purchase Order (PO)

In one embodiment of the invention there is provided a method, system and device for supplier related financing (trade credit) to GSPs, by:
1. establishing which GSPs have expertise to fulfill a job specification as specified as required by a PPSO's Purchase Order (PO); and
2. verifying that a GSP can meet a PPSO's PO specifications as reflected in the documentation provided in their PO, by looking at concurrent POs that the GSP has undertaken as well as historical POs as shown by settled, past and completed GSP invoices stemming from these POs, to confirm a GSP's operating capacity, to complete similar POs.

Capacity is an essential component here, since completion of the task in a suitable time and quality results in a satisfactory (or otherwise, if not so completed) outcome with regard to payment of the GSP invoice. This time and quality dependence aspect, in the delivery and quality of services received, is usually performed by one or more of the following:
a. the PPSO's internal customer (such as the department confirming the satisfactory supply of the goods or service);
b. the PPSO's external beneficiary (such as the insured car owner who is the recipient of the car repair ordered by an Insurance Company PPSO); and/or
c. on occasions by an external inspector expert in assessing the quality of the goods or services being supplied by the GSP.

GSPs are typically best placed to satisfy the time and quality requirements of successfully completing their sales efforts. If they lack a well-developed capacity, for achieving the delivery of quality of services in a timely manner, they do not get repeat business requests from their customers.

Delays in achieving successful completion to a satisfactory stage, so that the end customer does not recommend payment of the GSP's invoice by the PPSO's accounts payable department, will result in delayed or incomplete payment of the GSP's invoice by the PPSO.

Consequently, the payment history of a GSP's invoices for similar jobs in the past that is accessible to potential trade credit suppliers, via the embodiments of the invention, is a valuable tool for suppliers, PPSOs and/or PPE businesses to use when assessing the operating capacity of a GSP when making a trade credit decision about providing a GSP with trade credit.

Credit Enhanced Environment without Requiring a Sponsor

The device, method and system assists GSPs in providing more and easier trade credit from suppliers without requiring sponsors by making trade credit available provided they at least have a good operating history in their chosen business specialisation and are able and enabled to obtain a PO of a PPSO whose credit standing is widely relied on in the industry.

The preferred embodiment enables GSPs to approach any PPSO and bid for their business secure in the knowledge that, if they win the business, then the device leverages the PPSO's PO to open up trade credit from suppliers familiar with the PPSO to the GSP. Suppliers are enabled, via the device, to independently perform investigations to obtain comfort with the residual operating risk of the GSP, so they are enabled to assume this residual risk and grant new trade credit to the GSP.

If suppliers, after viewing a previously unknown GSP's PO, decide to seek the business, the GSP and this new supplier is enabled to quickly agree in principle to transact with each other so their negotiations can focus on price and delivery time as opposed to satisfying credit checks since they are dealing with each other in a credit enhanced environment.

A GSP and a new supplier are enabled to negotiate via the device. Once negotiations have being successfully concluded (online or off-line), the new supplier's quotations or invoices are enabled to be input via the interface of the device so they are made available to the GSP, optionally via a PPE Business, to review.

If these quotations are acceptable, either party is enabled to complete the contract (or finalise some other formal arrangement), via the interface of the device, with the timing of the supply of goods and/or services agreed and the new supplier's invoices are associated with the specific PO.

What previously may have taken days or weeks to set up and complete (the establishment of a new trade credit relationship) between previously unconnected parties, such as GSPs with new suppliers, can now be reduced in time and effort to a fraction of what it used to be, whilst providing greater confidence that the transaction(s) will be conducted within the pre-agreed terms.

By enhancing the efficiency of transactions by opening up more trade credit to GSPs from a wider range of suppliers, the competitive position of smaller GSPs is enhanced, so they are better enabled to compete with larger GSPs for business across the economy.

### Barriers to Settlement of a Purchase Order by a Goods and Services Provider

Typically GSPs are not as well placed to access the PPE required to access funds from a PPSO on a timely basis or successfully manage all parties involved in a B2B transaction as a specialist PPE Business.

For example, when a car repair is performed by a GSP (such as a smash repairer) and paid for by a PPSO (such as an insurance company), the parties involved are:
1. the recipient(s) of the goods or service provided (for example, the recipient of a car repair is the car's owner);
2. the GSP services provider (for example, a smash repairer),
3. the suppliers of goods and services to the GSP (for example, a car parts dealer); and
4. the PPSO who is the source of the ultimate payment of funds (for example, a motor insurance company) including the PPSO's agents such as an external inspector.

From a review of the above parties involved, it appears initially to be relatively straight forward for a GSP, such as a smash repairer, to access appropriate payments from a PPSO (the insurer). However, in practice, barriers exist due to the insurers internal procedures which require the smash repairer to have PPE for all the insurers they deal with.

This is a common problem in business to business supply chains as the end PPSO's payment is usually not at the discretion of the GSP. For example, a GSP who is a smash repairer requires approval from the PPSO or insurer, which is determined by who the car owner is insured with. There are well over 190 insurers and assessors (who may receive invoices on behalf of insurers) identified nationally in Australia which, as cars do travel interstate and have accidents, could all potentially be insurers and assessors for which a GSP (e.g. a Smash Repairer) has to learn how to deal with.

As simple as the PPE may be (and sometimes it is quite complex) no GSP such as a smash repairer is abreast of all these insurer's and assessor's PPE requirements or even abreast of which office of a national PPSO to deal with. Therefore in practice this PPE knowledge deficiency limits a GSP's timely access to repayment funds for their repair invoices.

The device, method and system in its variety of embodiments specifically assists in overcoming this PPE problem, whether or not a PPSO has its own proprietary system to eliminate this PPE gap or not.

In one arrangement of the above embodiments, the payment to GSP (e.g. a smash repairer for goods and/or services provided) by a PPSO (insurance company), is performed as follows:
(i) automated payments incorporating a PPSO's existing PPE method, system and device such that processes are automated. This enables:
   a) each party (such as the GSP, the trade credit supplier(s) and the PPSO) to enter their net payment requirements; or alternatively
   b) the GSP nominates a PPSO's existing PPE system, to receive all gross payments on its behalf, to control all further disbursement and/or completion detail to be verified by counter parties, so that once verification has been completed, then settlement in the form of payment occurs. This method utilises the requirements of establishing and verifying credit trustworthiness, as detailed above, along with the inclusion of additional steps of verification of task completion by one or more parties involved and use of a PPSO's existing PPE system. This incorporates disintermediation, via the removal of intermediaries, to increase the efficiency in the transactions;
(ii) transacted payments by an independent party to the PPSO (such as a specialist PPE Business), where the PPE obstacles confronting the GSP are outsourced to a PPE Business who utilises the device and interface to obtain efficiencies as follows:
   The GSP receives more timely access to funds from the PPSO via the device, which directs the payment from the PPSO for the GSP's invoice to the PPE Business's bank account on behalf of the GSP, so that in turn, the GSP's trade credit suppliers are enabled to be promptly paid under the supervision and control of the PPE business.
   Assurance of the prompt repayment of a GSP's invoices from its suppliers being overseen by either (i) or (ii) above ensures the trade credit suppliers are paid promptly and this assists a GSP to access further trade credit from these suppliers; or alternatively,
(iii) factored payments by an independent PPE Business where the device enables authentication and verification of an invoice associated with a PO from a GSP which satisfies the PPSO's pre-conditions for it to accept and approve for payment of the GSP's invoice.

In the preferred embodiment, the functions of the PPE business as an independent party overseeing the disbursement of funds when paid by the PPSO (as in (ii) above), or as a factoring business disbursing its own factoring proceeds (in (iii) above) are enabled to be disintermediated, so these functions are now enabled to take place through the described method, system and device.

The preferred embodiment will now be described by way of example as applied in the scenario involving a car insurance transaction.

The device, method and system assists in making the provision of trade credit by suppliers to GSPs more efficient by automating the following steps:
a) upon quote acceptance by the PPSO (here, the insurance company), the PPSO issues a PO (in this example, a repair authority)′ to the GSP (the smash repairers), enabling either or all to enter the PO detail into the PPE interface of the device:
   (i) the GSP;
   (ii) the PPE Business, and/or
   (iii) the PPSO;
b) the PO is independently verified via:
   (i) rule-based verifications enabled by the device; and/or
   (ii) via the PPE business;
c) the device enables the authenticated PO, as issued to the GSP by the PPSO, to be published so details of the PO's requirements, which in turn take the form of a GSP's requirements of its suppliers are enabled to be viewed, via an interface or via other publication mediums including applications, webpages, intranet site, SMS, etcetera, by potential suppliers to the GSP;
d) potential suppliers review the verified PO to gain assurance that they are being requested by the GSP to services and/or supply parts (on credit) to the GSP for a repair that the PPSO has agreed to pay for;
e) trade credit from suppliers to the GSP is provided more efficiently by:
   (i) overcoming the difficulty of independently verifying the authenticity of the PPSO's PO issued to the GSP; and/or
   (ii) giving the suppliers comfort that they will be paid promptly for the invoice via the PPE business intervention, at the same time as the GSP is paid for its invoice.
f) a GSP is enabled to have trade credit relationships with many suppliers without additional effort because its credit standing is less important than the credit standing of the PPSO's PO; thus, trade credit is enabled to be sought on a competitive basis;
g) the interface of the device is also enabled to be optionally viewed in alternate embodiments with additional detail including:
   (i) the history of the GSP success in completing similar PO's/repairs; and/or
   (ii) the availability that the GSP has to perform the repairs—that is, the GSP's capacity to carry out the work in a timely manner;
h) suppliers to the GSP are enabled to nominate to supply goods and services to the GSP on credit, so as to supply goods or services to potentially enable the GSP to complete the tasks specified on the PO;
i) suppliers are enabled to, in turn, use the interface of the device to display their supplier pricing and associated information (date, delivery detail etc.) for the supply of these goods and services to the GSP;
j) the GSP, via the interface of the device, is enabled to view the offers from the suppliers, so, if the price and terms are agreeable, the GSP is enabled to use the interface to accept the offer and link the chosen supplier's invoice(s) to the GSP's PO associated with the supplier trade credit.
k) This “linking” of the supplier's invoices with the GSP's PO via the interface of the device enables three or more parties using the device including:
   (i) one or more suppliers, the GSP, and preferably, the PPE Business) to be bound by an agreement such as a tripartite agreement (for example, when involving a supplier, the GSP and the PPE Business) or,
   (ii) in the case of the PPSO involving party to party sub-agreements (since the supplier has reliance on the verified PO from the PPSO, but has no contractual relationship with the PPSO), whereby parties agree that once the repairs are completed, the invoice must be sent via the PPE Business from the GSP to the PPSO for payment. This must be done via the PPE Business, so it is enabled to send it on the PPSO and arrange to receive the funds directly from the PPSO into its own bank account on behalf of the GSP.
l) The device and/or the PPE business organises and manages communications to the PPSO, so that the PPSO is satisfied to pay the funds owing on the invoice to the PPE business (as opposed to paying the GSP directly), so the PPE business is enabled to then allocate the funds from the PPSO to either itself, and/or the GSP and the supplier, so they both get paid at the same time.
   In this scenario, there is then no possibility of additional delay once the PPSO pays the GSP's invoice via the device to the PPE Business. The GSP does not have the option to choose to delay payment to the supplier, so as to improve the GSPs own cash position at the expense of the supplier.

### The Device Interface

The preferred embodiment's device provides PPE automation efficiencies via the device's rule based infrastructure which provides management functions linking the various parties typically involved in a business transaction so that they benefit from higher quality information flows, along with clerical and administrative operating efficiencies typically well above those of GSP's own unassisted efforts.

The interface of the device enables agreements to be entered into, such as the agreement between the GSP and/or the supplier, and/or the tripartite agreement between the GSP, the supplier and the PPE business, whilst stipulating the specific PPE requirements of the specific PPSO, so that these requirements are efficiently met as the device's PPE processes to efficiently transact with the PPSO (the Insurer) better than the GSP would otherwise. Aspects of the interface of the device are shown in FIGS. 3 to 5.

A Supplier is enabled to be informed via the interface of the device as to when an invoice of a GSP containing the supplier's costs (via the Supplier's invoice(s)) against a specified PO has been:
1. invoiced to the PPSO; and
2. followed up by the device, with or without the involvement of the PPE business, GSP or other party,
   so that the invoice is paid in good time and without unnecessary mishap, delay or reduction.

Where the device, in conjunction with a PPE business, is enabling factoring functions, then suppliers will have the additional comfort of knowing that the payment due for the goods and services, as supplied on credit, is scheduled to be paid via the device, at a relatively earlier date from the factoring proceeds, as opposed to the absence of the device.

Suppliers are scheduled to be paid when the GSP sends an invoice, via the device to the PPE business and the PPE business (where it is a Factor) determines to purchase the GSP invoice, and not at the later date when the PPSO pays the GSP's invoices after being chased by the PPE business for prompt payment.

When the invoice is sent by the GSP to a PPE business that is a Factor (who uses the interface of the device), the Factor allocates the factoring advance funds available to purchase the invoice from the GSP to first pay the supplier's invoices associated to the PO that gave rise to the GSPs invoice now being factored. This scheduling of when to be paid (the trigger for payment) is set within the preferences of the device. The suppliers will get paid first by the Factor out of the factoring advance funds. Only then does the GSP get paid from the residual funds left over after the Factor has met its commitments to the suppliers and any fees it is owed by the GSP for undertaking these services for the GSP.

Use of the device enables parties to meet the separate and disparate needs of each party including the following:
1. GSP: enabling the GSP easier and more substantial access to financial support by way of trade credit from their suppliers (rather than having to pay cash on delivery or in advance);
2. Suppliers: the device's management of verification of POs establishes the authenticity of the GSP's need for the requested parts/services along with providing various separate agreements between the three parties, which enables assurance to be provided to each and all supplier(s) that they are scheduled to be paid, for example, at the same time as the GSP is to be paid by the PPSO (or via some other timing arrangement);
3. PPE Business: The PPE Business using the device (whether to perform factoring functions or not) are enabled to receive the funds directly after the funds are paid by the PPSO or the Factor for the invoice(s). These funds alternatively are available to be paid to the GSP (for example, when no Factor was involved) after first debiting the GSP's account for any adjustments performed for PPE services. Alternatively, a PPE debit may be performed, for example, to the GSP's payment by the PPSO, for any PPE Business's fees (and factoring fees and any other adjustments) before the GSP's suppliers and the GSP itself are paid; and/or
4. PPSOs also benefit by the increased efficiency through decreasing errors in the incorporation of the device with their approval and payment gateways, although they are not direct participants in the device, method and system.

### Provision of Historical Information

In an alternative arrangement, there is a history provided via the device which is illustrative of the GSP's ability to satisfy similar POs from PPSOs in the past as selectable by chosen date ranges. This enables the supplier to review and decide whether they are comfortable with the GSP's ability to successfully complete the requirements of the PO if they supply the required parts and/or expertise.

By suppliers receiving notice of an authenticated PO via an interface of the device, smaller GSPs become potentially more accessible clients to a larger range of suppliers. Suppliers are also assured that the GSP will pay their invoice on a timely basis, since the device, optionally with the involvement of the PPE business, is independently providing assurances by:
1. authenticating the insurer's PO via a transparent and efficient method, performed in a less costly and less error prone environment; and
2. providing insight into the GSP's history of successfully handling the operating risks inherent in the PPSO's current PO. This is enabled by showing past POs (which may be filtered to only include similar POs and further filtered for only the recent history) and the associated GSP's invoice(s) that were paid promptly by the PPSO without negative adjustment.

Conversely, a history of invoices for similar POs being paid slowly and with negative adjustments is possibly indicative of poor performance and requires further questions of the GSP by the potential supplier.

This additional information to Suppliers, as facilitated by the device, increases supplier's confidence in any trade credit decision they subsequently make.

This PO and invoice history provides not only the supplier assurance via the device and/or PPE business, of a GSP's operating capacity but also provides assurance of the timely payment via the flow of funds being controlled to ensure that GSPs and their suppliers both get paid at the same time.

GSPs are therefore enabled to be introduced to more suppliers via the device which is performing the task of facilitating a wider distribution of the verified PO statement of requirements sought from suppliers (published via the interface of the device). This enables more suppliers to view, quote and supply against the verified and published PO statement of requirements on the interface to the device.

The device is enabled to more efficiently initiate, manage and complete the negotiation and agreement of business terms for the supply of specified goods and services on agreed credit terms between the two parties.

These parties, who may never have transacted with each other before, but for the device, method and system, would probably not have been able to satisfy each other's business and credit needs. The device now enable the parties to see each other's potential business offerings and requirements along with enabling them to reach agreement more quickly due to requiring less administrative effort or need for time consuming negotiations about the credit terms.

This assists new business between new parties by reducing the risk and providing additional efficiency and financial comfort to transacting businesses. Previous impediments to possible business relationships are minimised and therefore more business opportunities are enabled.

The device may also be used so that completion of transactions are overseen by an independent party, such as a PPE Business; however, the device, method and system does not need a PPE Business or any other financial intermediary to act as a sponsor of the GSP buyers or suppliers or to guarantee the performance of their financial obligations. This is a differentiating element from the prior art solutions discussed within the background. The prior art requires a buyer and/or seller sponsorships, which precludes a wide range of GSPs if they cannot get such sponsors.

### GSPs and Suppliers Transacting Via the Interface of the Device

The offer and acceptance of an agreement is enabled via the device so that terms of the agreement can be verified and held/retrieved from the device as required so that transparency and historical reference back to the transaction is able to be verified both independently and jointly.

Parties involved in such an agreement are captured by the device and are enabled to view and substantiate steps/stages leading to, and verification of, the requirements specified for completion of the agreement.

The linkage of the transactional steps, such as delivery of goods at a specified time and place by the supplier, contained as explanatory detail in the invoice to the GSP and as embodied in the PO enables review and verification by the parties who are transacting via the agreement.

The mutually agreed linking of supplier's invoices with the PO, which the GSP has received from the PPSO via the interface of the device, enables the parties to efficiently confirm that the parties commit and complete in a binding manner, with the specific transaction details being specified and confirmed, as shown in the following example:
1. the invoice from the GSP, whose creation is triggered by the GSP's conclusion of work specified in a PO from a PPSO previously input into the device, to be sent by the GSP via the device to:
   (i) the PPSO; or
   (ii) the PPE Business (not directly to the PPSO), where the invoice then becomes the responsibility of the PPE Business to present to the PPSO and follow up for full and timely payment by the PPSO;
2. the device and/or the PPE Business will arrange with the PPSO for payment of the GSP invoice to come directly to the device and/or the PPE Business, and not to the GSP; and
3. the device and/or the PPE Business, when it receives the funds from the PPSO in payment of the GSPs invoice undertakes to distribute the funds it received from the PPSO to pay:
   (a) first, the suppliers invoices linked via the interface of the device to the PO relating to the GSP invoice now paid, then
   (b) secondly, if involved, to pay amounts owing to the PPE Business; and
   (c) finally, the device and/or PPE Business pay the residual funds, remaining after (a) and (b) are paid above, to the GSP.

The device and/or the PPE Business grants access via the interface to both. GSPs and their suppliers, so that the parties and/or a PPE Business are enabled to view both sides of the transaction. In one arrangement, preferably each party may verify the counter party's completion of the required transactional steps. The device and/or the PPE Business facilitates the completion of the contract(s), once appropriate verification of the required transactional steps have taken place, on behalf of both parties.

### Features of the Device and its Interface

In FIG. 2 a flowchart shows a method, enabled by the device, for transacting agreements and payment between multiple parties such as a PPSO, a GSP, suppliers to the GSP and preferably a PPE business, as linked via the PO/Repair Authority. FIG. 2 only shows the broad steps, for which there are many substeps performed as described in the description.

Referring to FIG. 2, the broad steps as well as substeps are in part or fully mediated by the device, include the following:
1) the PPSO (an insurance company) decides it needs the services or products of a GSP (say as a result of an insured car owner advising the PPSO of an insured accident with a car in the car example) and enters these details into the interface of the device and communicates this detail to one or more GSPs who are locally available and/or have required expertise;
2) the GSPs (a smash repairer) review the work required and provide quotes to the PPSO via the device's interface;
3) the PPSO either accepts or amends the most suitable quote;
4) upon agreement of the quote, the PPSO issues its PO via the device to the selected GSP (this is called a Repair Authority in our car insurance example) based on their quotation.
   This Repair Authority, like any PO, is an undertaking that the insurance company is scheduled to pay the GSP to the value of the Repair Authority if (and when) the repair is subsequently completed by the GSP using repair standards common in the industry and appropriate to the work performed. It is equivalent to a contingent promise of payment from the PPSO, which is the insurance company in our example. This detail is specified in the PO is entered into the device;
5) the GSP allows one or more chosen suppliers (or all suppliers) to view the PO's details via the device and offer to supply services and parts to the GSP against that PO and the accompanying “undertaking” by the PPSO to pay the invoice of the GSP once the terms of the PO are satisfied by the GSP;
6) the GSP and the supplier directly agree via the device to the terms of supply, quantity, dates, pricing for the goods and services the supplier chooses to supply to the GSP. The supplier lodges their supplier's invoice via the device to the GSP for review and acceptance. The supplier invoice, once accepted by the GSP, again via the interface, links together the PO (as received from the PPSO) with the supplier's invoice and the GSP's invoice (if available at this time or subsequently when it is available) in preparation for submission of the GSP invoice to the PPSO in conformity with all the PPSO's PPE requirements.
   The effect of this offer and acceptance, as agreed, transacted and/or verified by the device, is to create a binding agreement between the parties (including the GSP, the supplier(s) and optionally the PPE Business if involved). When the GSP's invoice is issued for the work performed, relating to a specific PO, it is paid by the PPSO (or optionally by the PPE business if one is involved and it is a Factor).
   The payment of the GSP invoice is scheduled to pay the linked or associated suppliers invoices simultaneously (or as arranged depending on payment terms) with the payment of the GSP via the device. This provides the suppliers assurance of prompt payment of their invoices;
7) when the invoice is issued by the GSP for the work performed that relates to a specific PO, it is lodged within the interface of the device, (or physically mailed or faxed to the PPE business to be input into the device on their behalf), and then on-sent by device to the PPSO. Here the device, uses either its rule based system as to the PPE requirements of the PPSO, and/or by the intervention of the PPE business, applying its specific rules and/or knowledge of the PPSO, to determine how, where and when it can be best delivered to the PPSO;
8) the PPSO arranges for payment of the invoice and, via the device, this payment is automatically split between the GSP and the suppliers associated with the invoice, along with any fees for access to the system, so they are all paid at the same time, unless some other payment arrangement has been specified with in the device.
   The device applies its PPE rule-base to communicate information to the PPSO to satisfy its internal requirements so the GSPs invoice is paid in a timely basis and in full by the PPSO.

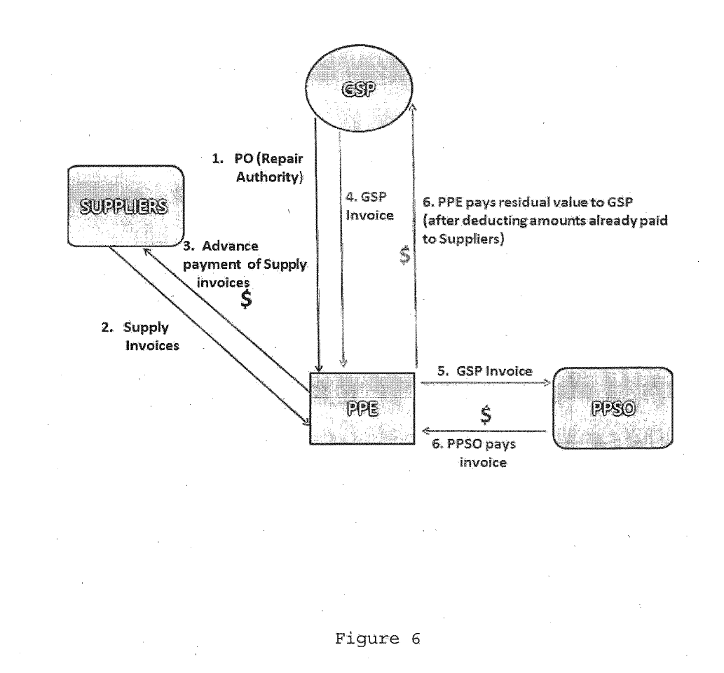

In additional embodiments, the device enables alternative approaches, depending on whether a PPE Business is or is not involved and/or (in addition) whether or not the supplier seeks early payment of its invoices (regardless of whether the GSP's invoices are completed and/or factored or not):
a) If neither the GSP nor its supplier requires the GSP to factor its invoices, and there is no PPE Business involved, the device manages invoices with payment to the GSP to only be made out of the proceeds paid by the PPSO, on behalf of the GSP, for the invoice. This is the antithesis of factoring in that it takes the form of disintermediation in that it removes intermediaries in the transactions by “cutting out” factoring services.
   Alternatively, if the device receives funds from the PPSO for the GSPs invoice, it will apply the funds received as is set within the device's payment schedule to first pay the suppliers then to pay the GSP whose invoices were “associated” or linked on the interface of the device with the PO; or
b) If a PPE Business is involved that is not a Factor, it is enabled to, via the device, exercise its pre-agreed right (via its “user agreement” with the GSP) to buy the GSP invoice with payment to the GSP at a later date out of the proceeds received from the PPSO for the invoice. Again this is the antithesis of factoring.
   In this alternative arrangement as shown in FIG. 6, the PPE Business via the device will send the GSP's invoice to the PPSO (step 5) with arrangements for payment of the invoice by the PPSO to go to the PPE's bank (step 6) account instead of, for example, the bank account of the GSP.
   Here, the PPE Business will apply its PPE expertise via the device to work with the PPSO to satisfy its internal requirements so the GSPs invoice is paid on a timely basis and in full. The device provides a means of arbitrage for the PPE Business to provide a competitive service to GSPs.
   When the PPE Business receives funds from the PPSO for the GSPs invoice it applies the funds it has received to first pay the suppliers (step 3) then the GSP (step 4), whose invoices were “associated” or linked via the device. Here the device provides as payment prioritisation scheduling service.
   The PPE Business is also enabled to use any residual funds received from the PPSO, post settlement of the supplier's invoices, to pay its fees or other amounts owing by the GSP.
   An example of this is a pre-repair payment to suppliers by PPE (with or without subsequent factoring of GSP invoice by PPE after repair or service completed) is shown in FIG. 6; or
c) Alternatively to the above, if a PPE Business is involved and it is to factor the GSP invoice it has received before sending it to the PPSO then it calculates a discounted value owing to the GSP for the invoice. The factoring proceeds received are then used to settle/pay the outstanding invoices from one or more suppliers to the GSP as linked via the PO on the device. These will be paid along with any factoring fees and fees for access to the device. Only then is the GSP paid the net amount left over, if there was a residual payment due under the terms of the factoring agreement.
   In this alternative further embodiment, the Factor then sends the invoice to the PPSO, and then collects from the PPSO in due course, so as to repay itself for the payment previously made to the GSP's suppliers and to the GSP.
   Alternatively still further, if the PPE Business involved is a Factor for which:
      (i) a GSP simply chooses to rely on for the skill of the PPE Business to achieve prompt and complete payment from the PPSO, but does not wish to factor its invoices; and
      (ii) supplier(s) to the GSP are not prepared to wait until the PPSO pays the GSP's invoice (or payment to be directed to it by the device and/or the PPE Business) but seeks an early payment of its invoice on behalf of the GSP,
   then in this case the PPE Business still functions as a factor but only to partially factor the GSP invoice to the extent necessary to generate sufficient funds to pay the suppliers invoice. This is enabled to be mediated by the device.
   In this instance the early payment of the supplier's invoice will be for less than or equal to the supplier's invoice full value depending on the supply terms agreed. Where the early payment of the supplier's invoice is equal to the supplier's invoice full value, then the PPE Business/Factor reimburses itself out of proceeds received from the PPSO for the GSP invoice, if so agreed. These terms are enabled to be negotiated via the device.
   The factor retains for itself any early payment discounts it earned from the supplier (net of the amount of any early payment discounts the GSP would have earned had the suppliers invoice only been paid on the later date when funds were received from the PPSO in payment of the GSP's invoice).

It can be seen in the above that no external funding from financial institutions is required for the device/system to generate the previously detailed benefits for GSPs and their suppliers.

The more successful the PPE Business is in applying its specialised PPE skills to obtain prompt and complete payment of GSP invoices the more profitable the PPE business is. Therefore, the arbitrage that the device provides enables a PPE Business to be more effective. The device enables more efficient and prompt flow of cash between transacting parties which are otherwise (and currently) eroded by delays.

### Computer Mediated Implementation of the Above Business Method

The preferred embodiment of the device encompasses the above method so as to enable one or more GSPs, such as smash repairer(s) and their associated parts supplier(s), to review the PO as issued from the PPSO to the GSP, at an agreed stage and also to review the GSP's past history of successfully fulfilling the requirements of similar POs as well as the PPE's business history and experience in processing these invoices, so that the supplier(s) is enabled to, if they wish, bid to supply the required parts. If the bid is successful, the supplier(s) attach their invoices to the PO (Repair Authority) with the legally binding consent of the GSP.

The device enables a PO (or Repair Authority) that has been issued to a GSP by a PPSO, to have its potential value realised by the GSP via the device:
a) verifying and/or authenticating the PO;
b) displaying its verified/authenticated contents to suppliers;
c) providing additional comfort for payment not only to the GSP but also at the same time a promise of payment to the GSP's suppliers effectively backed by the PPSO.

This reduces what was previously a raw unmitigated “credit risk” decision by potential suppliers to a GSP by providing sufficient detail and financial comfort that suppliers will be paid for the trade credit that they advance to the GSP provided the GSP can satisfactorily complete the repair detailed in the PO. The device and method therefore provides the supplier with the easier task of assessing the lower risk assessment of the “operating risk” inherent in the dependency on a GSP successfully satisfying the conditions of a PO. That is, the likelihood of a GSP completing the requirements stipulated in the PO is where the risk resides.

It is easier for suppliers, via the device and method, to obtain a high level of confidence on assessing this residual GSP operating risk by using their own industry knowledge and the historical information in the device that is available for review, so as to reveal the GSP's history with similar transactions, including where and when they failed. This detail is available via a reporting function generated via the device.

Once the PO is issued, there is often a delay, perhaps in the order of weeks or months before the repairs are completed, which impacts on when an invoice from the GSP is enabled to be generated. During this delay, the PO is worthless to the GSP without the benefit of inputting it into the device, since it has no tangible monetary value to the GSP until the conditions that enable the PO to be converted to an invoice for issuing to the PPSO are satisfied and a payment from the PPSO can be pursued. However, once the PO is in the device and available to suppliers for viewing, then goods and services can be immediately supplied to the GSP, due to the trade credit strength of the PO. The device therefore ensures the PO's immediate realisable and fungible value, which is not practically available without the intervention of the device and the assurance of prompt payment it provides.

Utilising the preferred embodiment, the interface of the device allows information, such as POs, to be entered into the device, which enables the flow of information to have an immediate reliable worth. This value is enabled since there is conversion of:
i. a future conditional promise to pay in the form of an unverified PO into;
ii. an authenticated promise of prompt payment in a low risk environment that is of real worth to potential suppliers provided they can accept the operating risk of the GSP in satisfying the conditions of the PO.

Effectively, this moves the PO from a future promise to pay value only to the GSP to an immediately “tradable” promise of subsequent and above all prompt payment to a GSP's suppliers. The PO's immediate realisable worth is based on the linkage of chosen supplier's invoices to the GSP's PO and the subsequent invoice the GSP creates for the PO via the interface of the device, in conjunction with the transactional information consisting of knowledge that:
1) an invoice, once issued by a GSP, enables the supplier to be paid at the same time as the GSP by the device; however, the supplier may be scheduled via the device to have the first call and earlier access to the available funds as set within the preferences options of the device; and
2) if money is paid to suppliers of a GSP via a PO and subsequently there is a dispute regarding the GSP's invoice relating to that PO, then as a matter of policy money is not demanded back from the suppliers that supplied goods and services in good faith to the GSP relating to the PO that created the problem invoice. This is managed by the device so that many scenarios can be created including whether or not there is a PPE Business involved and whether it is acting as a Factor.

Here the traditional risk that a PPE Business or that a Factor carries along with the credit risk that suppliers have is now reduced and specifically the supplier risk is spared. This is due to the verification of the PO and tasks performed as linked under the PO are not restricted to being managed by the GSP alone, but are available to be viewed by all parties involved. Therefore, the device and the method of using the device enable the supplier's credit risk to be mitigated by an authenticated PO available for viewing on the device. All linked suppliers invoices are paid from the same source as the GSP out of the PPSO's payment proceeds via the PO and subsequent related GSP invoice regardless at what stage or time they are paid.

This is a significant shift in the risk profile in performing the above transaction, since the credit risk is now:
a) moved away from the suppliers; and
b) borne by the device through direct use or via a PPE Business/Factor without any increase in the traditional risk that a Factor has long experienced in assessing and managing invoice management/purchase or (in another variation of the device) by the Factor if it decides to pay the supplier invoices prior to needing an invoice from the GSP after the repair is completed.

The strict application of POs and suppliers invoice linkages and payment policies by the device, optionally with a PPE Business (whether a Factor or not), enables credit enhanced environments, via the device in conjunction with the method, to be generated, which benefits the parties involved.

The device's credit enhanced environment enables easier offer and acceptance of trade credit and business terms between GSPs and their suppliers such that dynamic supply negotiations can be performed in real time between the parties involved. These real time dynamic negotiations are enabled to be mediated via the device even if they know little of each other's business environment, practices or associated information pertinent to optimal business transactions.

The device therefore enables:
(i) immediate payment of supplier's invoice(s) when, obtained by the GSP when Factoring or pre-repair financing is involved; alternatively
(ii) greater assurance of prompt payment by the PPSO due to the device's embedded PPE expertise;
(iii) enabling a PPSO's PO information to be shared and include GSPs who might have weak credit standing with their suppliers and otherwise not being able to access trade credit easily or in the quantum they require.
   Benefit from the Device

Smaller GSPs (which is most of them) need access to adequate trade credit, which is often more important than price of supplies. This over-reliance on supply trade credit reduces a GSP's competitive ability relative to the larger GSPs who can afford to “shop around” with different suppliers to get the most competitive price, since large GSPs are not so financially constrained and are enabled to easily satisfy any credit checks suppliers may have.

That is, without the device, many GSPs cannot obtain trade credit in the quantity needed to service large PPSOs. Not only does the device, method and system help GSPs overcome this by removing this blocked access to obtain necessary trade credit, but it also enables PPSOs to receive more bids for their purchases of goods and services from these very numerous smaller GSPs. These GSPs, despite their small size and low credit standing, may be very reliable and low risk operators in their specialist field of activity, so the device, method and system produces competitive benefits for PPSO's even though they may be indirect device use participants.

The device improves the efficiency and timeliness with which cash flows between transacting parties as described in the above embodiments. The majority of the GSP are small businesses who generally have little PPE knowledge to assist their dealing with PPSOs and therefore benefit from the device's ability to speed up the flow of cash between all parties.

Inadequate free cash flow is a major impediment to business. To date GSPs with deficient PPE expertise have not been able to provide services to PPSOs as freely as they wished, as getting prompt payment from PPSOs is often beyond their ability to achieve, so their cash flow is often constricted. Typically this results in such GSPs having a poor creditor payment history and thereby tarnishing their already low credit worthiness and further limiting their access to trade credit

The timely payment of GSP suppliers at the same time, or before the PPSO pays the GSP, is a core benefit obtained with the device. The PPE advantage embedded in the device greatly benefits suppliers financially. The device also facilitates the provision of more trade credit to a broader range of GSPs than that would be available without the device. This enhances their supplier's sales volumes and trading profitability.

This method, system and device by creating a credit enhanced environment facilitated by the PPE Business for POs from PPSOs (such as Repair Authority's from Insurers) provides advantages over traditional systems where, for example, suppliers rarely saw the PO that GSPs had received from PPSO's or if they did see them had no knowledge of their validity.

Even if the suppliers did see the GSP's PO sent by a PPSO (common when the value of the transactions is extremely high), such problems also existed in traditional PO financing, when applied to very small GSPs (such as in the smash repair example), in that without the automation and credit enhancement and also validation provided by the device, it is unmanageable to efficiently or practically provide authentication and verification on the low value transactions that most GSPs (such as smash repairers) deal with, when satisfying the PO of PPSO's (such as repair authorities issued by Insurers).

Consequently, the embodiments above provide a new method, system and device for providing supplier related financing which has advantages over known systems.

The described method, system and device enables:
a) the early payment to GSPs suppliers based on the strength of the GSPs invoice or (if they repair is not yet completed and invoiced) on the strength of the GSP's past operating ability to satisfy the PO's requirements;
b) a PPE Business to be involved without factoring the invoice;
c) arranging with the PPSO for it to receive payment for the GSPs invoice directly from the PPSO on behalf of the GSP; then
d) paying the suppliers to the GSP only when it has received payment from the PPSO for the GSPs invoice.

The method, system and device does not require a mandatory credit check of the GSP by the PPE Business as minimal credit risk is being assumed by the PPE Business (the dominant residual risk becomes the operating risk of the GSP). As credit checks often see the financially weak or small GSPs, such as smash repairers, fail the credit checks they are unable to utilise such traditional factoring models.

The need for comprehensive supplier instigated credit checks on the GSP is removed which enables the GSP's verified PO to be transacted with certainty. When suppliers have certainty that they are scheduled to be receiving payment, either directly from the PPSO or via a PPE business, either before or at the same time as the GSP's invoice is paid in this credit enhanced environment, then financial transactions can proceed more efficiently. This efficiency, produced by the method, system and device, overcomes obstacles such as the necessity to perform credit checks on the GSP, which in our examples are the smash repairer(s) and removes delay in payment of trade credit.

The greater efficiencies of the method, system and device overcome the impediments that traditional Factoring businesses would be presented with. For example, one difficulty that a Factoring business traditionally encounters is obtaining sufficient assurance it seeks in purchasing a GSP's invoices. That is, that the GSP's invoices have an inherent value so that these invoices are scheduled to be paid (in a timely manner or eventually). This assurance, which is a form of risk, often results in the cost in obtaining such assurance, such as via credit checks, being too expensive for the small volume of factoring expected to be needed by the GSP, so the potential factoring transactions do not go ahead.

The advantage to the GSPs and the GSP suppliers (smash repairers and parts suppliers in our example) is that they are enabled to perform business with each other with greater efficiency than they would without the method, device and system. Which, to take our example further, by the intervention of the PPE business, overcomes the problem of a smash repairer not getting payment from PPSOs, such as insurance companies, due to the complicated procedures, where the GSP is not au fait with such procedures.

GSPs also avoid suffering reduced cash flow by effectively providing credit to a PPSO (an insurer in our example) while the PPSO often deals with the poor invoice data from GSPs, or there is inadequate follow up of the PPSO by the GSP to achieve payment of the GSP's invoice. This inadequate follow up is often due because of the GSP not knowing how, when or where to contact the right person or area in a PPSO. Consequently, the GSP is confronted with obstacles when dealing with one or more PPSOs since they are not able to decipher the processing and payment mechanisms relating to the settlement of their specific invoice.

This task is now undertaken by the method, system and device directly or as mediated via a PPE Business. This is particularly important since GSPs, such as the smash repairer and parts supplier in our example, are not skilled, nor have the time available, in negotiating with PPSO's systems. Likewise, PPSOs are not adept to dealing with, or teaching, their procedural requirements to GSPs, like smash repairers and parts suppliers. The unique combination of automation and credit enhancement of PO from PPSO's by the system, device and method overcomes these practical problems, optionally with the involvement of a PPE business, to make the promise of prompt repayment to suppliers a reality and trade credit consequently more readily available.

The use of the above embodied method, system and device for providing supplier related financing is an improvement over existing transaction systems available, thereby providing pre-completion of requirements for access to trade credit for GSPs and enhanced prompt payment confidence for GSP suppliers.

The credit enhanced environment to which the current embodiments gives rise has advantages over other factoring models, which only propose a payment to the supplier on behalf of the GSP when the invoice is presented to the Factor for purchase. In many instances the GSP may not wish to factor the invoice, but would preferentially only avail the services, provided via the device, method and system with or without the PPE expertise, so that the GSP can give assurance via the device to its suppliers that they will get paid faster and/or that future payment was a certainty. A further advantage of the above embodiments is that they work for both low value as well as high value transactions.

The need for providing the means of implementing the procedures required by GSPs, so they can get their invoices paid by their end customers, so as to, in turn promptly pay their suppliers is met by the device, method and system, which automates the obtaining of the required assurance for trade credit providers, so that trade credit can be quickly and/or inexpensively obtained by one or more GSPs. Similarly, where a Factor is involved, it needs to able to provide assurance to a supplier that it is acting for a GSP and providing prompt payment on the GSP's invoices once sent for factoring, to assist the supplier in deciding to grant the GSP more trade credit.

The invention provides a method, system and device for providing supplier related financing for use by the GSPs and GSP suppliers but it is also a means to obtain early payment from PPSOs.

However, it will be appreciated that the device is not restricted to these particular fields of use and that it is not limited to particular embodiments or applications described herein.

1-21. (canceled)

22. A computer program product embodied in a computer readable storage medium for providing supplier related financing to one or more Goods and Services Providers (GSPs), the computer program product comprising programming instructions for:
a) authentication of a Purchase Order (PO) sent to a Goods and Services Provider (GSP) from a Payment Procedure Specific Organisations (PPSO) such as an insurance company;
b) publication of the GSP's requirement for supply of one or more parts and/or services, for viewing by one or more potential suppliers;
c) matching of said offers of supply in the form of trade credit from one or more suppliers to the GSP's requirements and/or the associated PO specification; and
d) presentation of said offers of supply to said GSP.

23. A computer program product according to claim 22, further comprising:
a) presentation of the authenticated PO that nominates the GSP's requirement of supply to viewing suppliers;
b) identification and prioritisation of supplier's offers of supply by cost, availability and/or quality;
c) evaluation of similar repairs and associated invoices performed by a GSP to provide one or more said suppliers comfort that their offers of supply in the form of trade credit are able to be paid for by the GSP within a specific time period;
d) enabling additional information to be entered against a PO to enable provision of services on agreed trade credit terms held against a specific PO;
e) matching the offer and acceptance of terms by suppliers and the GSP respectively to form one or more agreements specifying ancillary information including one or more of the following:
(i) delivery date;
(ii) place of delivery;
(iii) condition of goods;
(iv) undertakings between the parties based on the input's received; and
(f) generating the agreement including the detail from:
(i) PO as the authorisation to perform work and to receive parts as a trade credit on one or more particular term's from one or more suppliers; and
(ii) the supplier's invoice with the specified terms of trade credit.

24. A computer program product according to claim 22, wherein the GSP's requirement for trade credit to receive supply of one or more parts and/or services, for viewing by one or more potential suppliers are enabled to be viewed on computer enabled devices such as interfaces to the device including networked publication mediums including applications, webpages, intranet sites, SMSs.

25. A computer program product according to claim 24, wherein the interface to the device is enabled to display suppliers aggregate trade credit amount available for supply of the required Goods and Services and associated information (including date, delivery detail) for the supply of goods and services to the GSP.

26. A computer program product according to claim 22, comprising: management the GSP's invoice preparation for submission to the PPSO, wherein said GSP's invoice contains GSP's and supplier's debits recorded to prioritise the payment of supplier's invoices in the form trade credit suppliers, related to the GSP's invoice and related PO.

27. A computer program product according to claim 26, wherein said GSP's invoice preparation for submission to the PPSO utilises Payment Procedure Expertise (PPE) to satisfy the information requirements of the PPSO, including meeting the specific policies and procedures along with practical requirements that are associated with the settlement of the GSP's invoice associated with the PO issued by the PPSO to the GSP.

28. A computer program product according to claim 27, wherein said settlement of the GSP's invoice is enabled to be performed as a factored payment by an independent PPE Business where the device enables authentication and verification of an invoice associated with a PO from a GSP which satisfies the issuing PPSO's pre-conditions for PPE Business's acceptance and approval to proceed with payment of the GSP's invoice.

29. A computer program product according to claim 22, wherein said programming instructions include automation of one or more of the following steps:
a) submission of GSP's quote and/or PO detail into the device;
b) acceptance of a GSP's quote by a PPSO;
c) issuance of a PO by the PPSO to the GSP;
d) verification of the PO issuance by a PPSO via rule-based verifications enabled by the device;
e) authentication of the PO as issued to the GSP by the PPSO;
f) publication of the PO's requirements to potential suppliers to the GSP;
g) nomination of the supply of goods and services by one or more suppliers to a GSP on credit against an authenticated PO;
h) specification of suppliers aggregate trade credit amount available for supply ofthe required Goods and Services and associated information including delivery detail, quality of services and/goods etc.) for the supply of these goods and services to the GSP;
i) acceptance by a GSP of one or more supplier's offers on trade credit that meet the GSP's acceptable price and terms and link the chosen supplier's invoice(s) to the GSP's PO associated with the supplier trade; and
J) generating and linking agreements and sub-agreements reflecting the offers, acceptance and associated terms.

30. A computer program product according to claim 22, wherein said supplier is informed via the device communications as to when an invoice containing the supplier's costs (via the supplier's invoice(s)) linked with a specified PO has been:
(a) invoiced to the PPSO; and
(b) followed up by the device, with or without the involvement of the PPE business, GSP or other party,
such that the supplier's invoice is paid in good time and without unnecessary mishap, delay or reduction.

31. A computer program product according to claim 22, wherein an invoice is communicated via the device by a GSP to a PPE business that is a Factor, the Factor via the device is enabled to allocate the factoring advance funds available to purchase the invoice from the GSP.

32. A computer program method for providing supplier related financing to one or more Goods and Services Providers (GSPs), the method being performed by a processor and comprising:
a) authentication of a Purchase Order (PO) sent to a Goods and Services Provider (GSP) from a Payment Procedure Specific Organisations (PPSO) such as an insurance company;
b) publication of the GSP's requirement for supply of one or more parts and services, for viewing by one or more potential suppliers;
c) matching of said offers of supply in the form of trade credit from one or more suppliers to the GSP's requirements and the associated PO specification; and
d) presentation of said offers of supply to said GSP.

33. A computer program method according to claim 32, further comprising:
a) presentation of the authenticated PO that nominates the GSP's requirement of supply to viewing suppliers;
b) identification and prioritisation of supplier's offers of supply by cost, availability and quality;
c) evaluation of similar repairs and associated invoices performed by a GSP to provide one or more said suppliers comfort that their offers of supply in the form of trade credit are able to be paid for by the GSP in at a specific time period;
d) enabling additional information to be entered against a PO to enable provision of services on agreed trade credit terms held against a specific PO;
e) matching the offer and acceptance of terms by suppliers and the GSP respectively to form one or more agreements specifying ancillary information including one or more of the following:
(i) delivery date;
(ii) place of delivery;
(iii) condition of goods;
(iv) undertakings between the parties based on the input's received; and
f) generating the agreement including the detail from:
(i) PO as the authorisation to perform work and to receive parts as a trade credit on one or more particular term's from one or more suppliers; and
(ii) the supplier's invoice with the specified terms of trade credit.

34. A computer program method according to claim 32, wherein the GSP's requirement for supply of one or more parts and services, for viewing by one or more potential suppliers are enabled to be viewed on computer enabled devices such as interfaces to the device including networked publication mediums including applications, webpages, intranet sites, SMSs.

35. A computer program method according to claim 34, wherein the interface to the device is enabled to display suppliers aggregate trade credit amount available for supply of the required Goods and Services and associated information (including date, delivery detail) for the supply of goods and services to the GSP.

36. A computer program method according to claim 32, comprising: management the GSP's invoice preparation for submission to the PPSO, wherein said GSP's invoice contains GSP's and supplier's debits recorded to prioritise the payment of supplier's invoices in the form trade credit suppliers, related to the GSP's invoice and related PO.

37. A computer program method according to claim 36, wherein said GSP's invoice preparation for submission to the PPSO utilises Payment Procedure Expertise (PPE) to satisfy the information requirements of the PPSO, including meeting the specific policies and procedures along with practical requirements that are associated with the settlement of the GSP's invoice associated with the PO issued by the PPSO to the GSP.

38. A computer program method according to claim 37, wherein said settlement of the GSP's invoice is enabled to be performed as a factored payment by an independent PPE Business where the device enables authentication and verification of an invoice associated with a PO from a GSP which satisfies the issuing PPSO's pre-conditions for PPE Business's acceptance and approval to proceed with payment of the GSP's invoice.

39. A computer program method according to claim 32, further comprising:
automation of one or more of the following steps:
a) submission of GST's quote and/or PO detail into the device;
b) acceptance of a GSP's quote by a PPSO;
c) issuance of a PO by the PPSO to the GSP;
d) verification of the PO issuance by a PPSO via rule-based verifications enabled by the device;
e) authentication of the PO as issued to the GSP by the PPSO;
f) publication of the PO's requirements to potential suppliers to the GSP;
g) nomination of the supply of goods and services by one or more suppliers to a GSP on credit against an authenticated PO;
h) specification of suppliers aggregate trade credit amount available for supply of the required goods and services and associated information including delivery detail, quality of services and/goods etc.) for the supply of these goods and services to the GSP;
i) acceptance by a GSP of one or more supplier's offers on trade credit meet the GSP's acceptable price and terms and link the chosen supplier's invoice(s) to the GSP's PO associated with the supplier trade; and
j) generating and linking agreements and sub-agreements reflecting the offers, acceptance and associated terms.

40. A computer program method according to claim 32, wherein said supplier is informed via the device communications as to when an invoice containing the supplier's costs (via the supplier's invoice(s)) linked with a specified PO has been:
(a) invoiced to the PPSO; and
(b) followed up by the device, with or without the involvement of the PPE business, GSP or other party,
such that the supplier's invoice is paid in good time and without unnecessary mishap, delay or reduction.

41. A computer program method according to claim 32, wherein an invoice is communicated via the device by a GSP to a PPE business that is a Factor, the Factor via the device is enabled to allocate the factoring advance funds available to purchase the invoice from the GSP.
